(19) United States
(12) Patent Application Publication
(10) Pub. No.: US 2025/0174674 A1
(43) Pub. Date: May 29, 2025

(54) COMPOSITE CATALYTIC MATERIAL AND FUEL CELL CONTAINING THE SAME

(71) Applicant: PROMETHEON TECHNOLOGIES BV, Zele (BE)

(72) Inventor: Zacariah Austin HEIM, Zele (BE)

(21) Appl. No.: 18/843,653

(22) PCT Filed: Mar. 3, 2023
(86) PCT No.: PCT/EP2023/055516

§ 371 Date: Sep. 3, 2024

(30) Foreign Application Priority Data
Mar. 4, 2022 (GB) 2203055.5

(51) Int. Cl. H01M 4/90; H01M 4/86; H01M 4/88; H01M 8/10; H01M 8/1004

(52) U.S. Cl. CPC H01M 4/9083; H01M 4/8668; H01M 4/8673; H01M 4/8825; H01M 8/1004; H01M 2008/1095

(57) ABSTRACT

The present disclosure relates to fuel cells comprising composite catalytic material comprising (N-doped) carbon nanofoam, catalytic metal and an electrically conductive material comprising an electrically conductive polymer. The fuel cells can advantageously operate at lower temperatures than standard fuel cells.

### FiELD

The present disclosure relates to fuel cell and, in particular, to a fuel cell of polymer electrolyte membrane, PEM, type. In particular, the present disclosure relates to a fuel cell configured to operate in both a redox mode and a regenerative mode. The present disclosure also relates to one or more catalysts for such a fuel cell. The present disclosure also relates to methods of forming said catalysts.

### BACKGROUND

Conventional electrochemical fuel cells convert fuel and oxidant into electrical energy and a reaction product. A typical layout of a conventional fuel cell comprises a solid polymer ion transfer membrane that is sandwiched between an anode and a cathode. The polymer membrane allows protons to traverse the membrane but blocks the passage of electrons. Typically, the anode and the cathode are both formed from an electrically conductive, porous material such as porous carbon, to which small particles of platinum and/or other precious metal catalyst are bonded.

The anode and cathode are often formed at the respective adjacent surfaces of the membrane. This combination is commonly referred to as the membrane-electrode assembly, or MEA.

Typically, the polymer membrane and porous electrode layers are sandwiched between flow plates. The flow plates, in a conventional fuel cell, provide for the delivery of reactants to the anode and the cathode and the removal of reaction products. The fuel cell may include porous gas diffusion layers fabricated so as to ensure effective diffusion of gas to and from the anode and cathode surfaces as well as assisting in the management of water vapour and liquid water.

in a typical application, one of the flow plates may include an anode fluid flow field comprising a plurality of channels to deliver hydrogen gas to the anode. Further, the other of the flow plates may include a cathode flow field comprising a plurality of channels to deliver an oxidant (e.g., oxygen gas) to the cathode. The flow field may also be arranged to remove the reaction products or water vapour.

Because the voltage produced by a single fuel cell is quite low, conventionally multiple cells are connected in series with the electrically conductive, flow plate on the cathode side of one cell being placed in electrical contact with the adjacent flow plate on the anode side of the next cell.

in order to simplify construction of a series-connected array or “stack” of fuel cells, it has been proposed in the prior art to utilise a single flow plate shared between adjacent cells termed a bipolar plate. At the ends of the stack, i.e., at the first and last fuel cells therein, the flow plates may be termed “end plates”.

The present invention is directed to providing improvements in the design of a fuel cell and of a fuel cell stack formed of such fuel cells.

### SUMMARY

The present disclosure relates to highly mesoporous (N-doped) carbon nanofoam materials that find particular use as a support scaffolding for catalysts in fuel cells, composite catalytic materials comprising the (N-doped) carbon nanofoam material, and fuel cells comprising the composite catalytic materials.

According to an aspect of the disclosure, there is provided a fuel cell comprising one or more first catalyst layers, wherein said one or more first catalyst layer comprises a composite catalytic material comprising
a catalyst comprising a metal or metal oxide of group 4 to 11, and
an electrically conductive material comprising an electrically conductive polymer,
said catalyst and electrically conductive material being supported by an (N-doped) carbon nanofoam material.

in one or more embodiments, there is provided a fuel cell (100) comprising:
a polymer electrolyte membrane (101) having a first electrode (102) on one side and a second electrode (103) on an opposed side, wherein the polymer electrolyte membrane (101), the first electrode (102) and the second electrode (103) are arranged between a first plate (104) and a second plate (105);
wherein the first plate (104) is arranged adjacent the first electrode (102) and the second plate (105) is arranged adjacent the second electrode (105), wherein the first plate optionally includes flow channels formed in a surface thereof facing the first electrode (102) and configured to provide fluid to and receive fluid from the first electrode (102);
one or more first catalyst layers between the first plate (104) and the second plate (105);
   and wherein
the one or more first catalyst layers comprises a composite catalytic material comprising
   a catalyst comprising a metal or metal oxide of group 4 to 11, and
   an electrically conductive material comprising an electrically conductive polymer,
   said catalyst and electrically conductive material being supported by an (N-doped) carbon nanofoam material.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future Claim sets. The figures and Detailed Description that follow also exemplify varlous example embodiments. Various example embodiments may be more completely understood in consideration of the following Detailed Description in connection with the accompanying Drawings.

### BRIEF DESCRIPTION OF THE DRAWiNGS

One or more embodiments will now be described by way of example only with reference to the accompanying drawings in which:

FiG. 1 shows an example embodiment of a fuel cell and schematically shows a fuel cell stack formed of such fuel cells;

FiGS. 2a and 2b show SEM micrographs of the N-doped carbon nanofoam material formed in Example 1;

FiG. 3 shows the RDE polarization curve of a test cell containing the composite catalyst material Co-PANi-PPyTsOH/N-doped carbon nanfoam;

FiG. 4 shows the performance differences between test cells with electrodes containing Co-PPy/N-doped carbon nanofoam and Co-PpyTsOH/N-doped carbon nanofoam catalysts;

FiGS. 5a to 5f show the performance (potential vs current density) of various composite catalyst materials formed under different conditions;

FiGS. 6a and 6b show TEM images of the ORR composite catalyst material PANi:polypyrrole-TsOH:(N-doped) carbon nanofoam material:CoP@a-CoOx as formed in Example 3;

FiGS. 7a and 7b show TEM images of the OER composite catalyst material PANi:polypyrrole-TsOH:N-doped carbon nanofoam material:cobalt as shown formed in Example 5.

### DETAILED DESCRIPTION

The disclosure provides fuel cells in various arrangements which contain an (N-doped) carbon nanofoam material, and various examples of the (N-doped) carbon nanofoam material in different arrangements that find various uses, particularly as a component in a composite catalytic material in a fuel cell. Particularly preferred types (N-doped) carbon nanofoam material that finds use in examples of the disclosure will be described in more detail below.

Example embodiments of a fuel cell will be described.

in one or more embodiments, the fuel cell may be configured to operate in both a conventional redox mode, in which a fuel and an oxidant is consumed to generate an electric current and one or more reaction products, and in a regenerative mode, in which a potential difference is applied to the fuel cell and at least one of the one or more of the reaction products are electrolysed to form said fuel. Thus, one or more example embodiments of the fuel cell comprise a reversible fuel cell. In one or more examples, one or more catalyst layers are provided to enable operation in said redox mode and said regenerative mode.

in one or more embodiments, the fuel cell may include a fuel storage material as a structure or layer with, i.e., alongside or forming part of, an electrode of said fuel cell, thereby providing a store of fuel within said fuel cell. In one or more examples, the fuel storage material is provided between first and second plates that contain an active region of said fuel cell.

in one or more examples, the fuel is protons and fuel storage material is configured to store said fuel.

it will be appreciated that the fuel cell may be configured to provide said redox and regenerative modes and not include said fuel storage material. It will also be appreciated that the fuel cell may be configured to include said fuel storage material without being configured to operate in said redox and regenerative modes. For example, the fuel cell may be configured to operate only in the regenerative mode and thereby function to store fuel in the fuel storage material for extraction. Alternatively, the fuel storage material may be provided with fuel and the fuel cell may be configured to operate only in the redox mode.

it will be appreciated that reference to the “fuel cell” can also be understood to refer to a stack of fuel cells given that, generally, the form of the fuel cell is replicated throughout the stack.

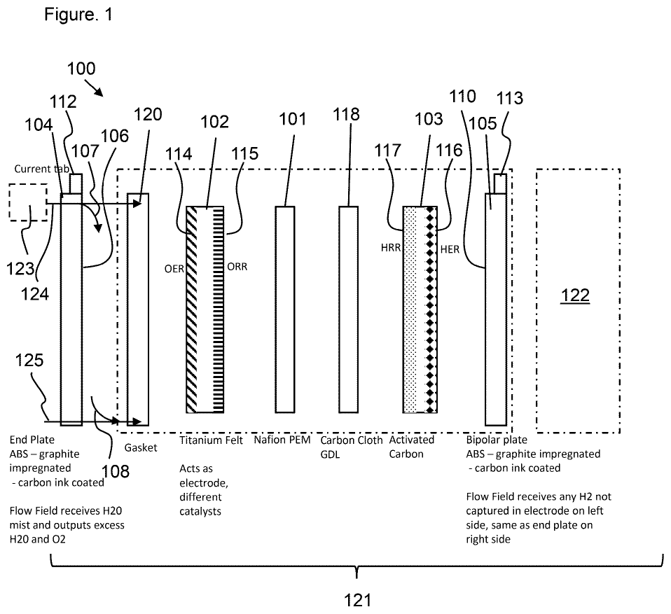

FiG. 1 shows an example fuel cell 100 according to an aspect of the disclosure. The fuel cell 100 comprises a polymer electrolyte membrane 101 or “PEM”. The PEM 101 comprises a semipermeable membrane and may be configured to conduct protons while acting as an electronic insulator and a reactant barrier.

The PEM 101 may be formed of ionomers and may, in one or more examples, comprise a fluorinated acid polymer.

Suitable fluorinated acid polymers are described below, particularly those in which the acidic groups are sulfonic acid groups or sulfonimide groups. Highly fluorinated and perfluorinated polymers with these acidic groups are particularly preferred.

Suitable polymers for use in the PEM include those sold under the Nafion® trade mark, such as Nafion® 211 and Nafion® 212.

The PEM may have a thickness of between 5 and 200 μm. In preferred embodiments, the PEM may have a thickness of between 10 and 100 μm, suitably from 20 to 75 μm.

The fuel cell 100 includes a porous, first electrode 102 on one side of the PEM and a porous, second electrode 103 on an opposed side of the PEM. Thus, the first electrode 102, the second electrode 103 and the PEM may be formed as a series of layers and the arrangement may be collectively referred to as a membrane electrode assembly or “MEA”.

The PEM 101, the first electrode 102 and the second electrode 103 are sandwiched between a first plate 104 and a second plate 105. The first plate and the second plate 104, 105 may comprise non-porous, rigid plates that provide structural integrity for the fuel cell 100. In other examples, the plates may flexible.

The first plate 104 is arranged adjacent the first electrode 102, such as directly adjacent. The second plate 105 is arranged adjacent the second electrode (105), such as directly adjacent. In one or more examples, the first plate includes optional flow channels (not shown in FiG. 1) formed in a surface 106 thereof facing the first electrode 102. The flow channels may be configured to receive a fluid, such as an oxidant, from one or more fluid inlets (shown schematically at 107) and distribute that fluid over the surface of the first electrode 102.

The fuel cell 100 may include a gas diffusion layer (not shown in FiG. 1) to further distribute said fluid from the flow channels to the first electrode 102. A gas diffusion layer may also optionally be included at other locations, for instance between first electrode 102 and the PEM 101, between the PEM 101 and second electrode 103, and between the second electrode and second plate 105.

Suitable materials to use as a gas diffusion layer include carbon cloth.

Preferably, the gas diffusion layer has a hydrophobic coating. A suitable hydrophobic coating is, for instance, PTFE.

The flow channels may alternatively or in addition be configured to receive fluid from the first electrode 102, such as one or more reaction products. The first plate 104 may further comprise one or more fluid outlets (shown schematically at 108) to receive said fluid from the flow channels.

in one or more examples, the second plate 105 includes optional flow channels (not shown in FiG. 1) formed in a surface 110 thereof facing the second electrode 103. The flow channels may be configured to receive a fluid, such as a fuel, from a fluid inlet (not shown) and distribute that fluid over the surface of the second electrode 103.

The fuel cell 100 may include a gas diffusion layer to further distribute said fluid from the flow channels to the second electrode 103.

The flow channels may alternatively or in addition be configured to receive fluid from the first electrode 102, such as unreacted fuel from the fluid inlet or fuel from the second electrode 103. The second plate 105 may further comprise one or more fluid outlets (not shown) to receive said fluid from the flow channels.

Each plate 104, 105 may include a current tab 112, 113 through which an electric current may flow during use. Thus, with such a configuration, the first electrode 102 is electrically coupled to the first plate 104 and the second electrode 103 is electrically coupled with the second plate 105. It will be appreciated that other means for providing an electrical circuit between the first and second electrodes 102, 103 may be provided that may or may not involve said first and/or second plates 104, 105.

The fuel cell 100 may include one or more first catalyst layers 114, 115 between the first plate 104 and the polymer electrolyte membrane 101. The one or more first catalyst layers may be configured to provide an active site for catalytic activity for one or both of an oxygen reduction reaction (ORR) and an oxygen evolution reaction (OER). Suitable catalytic materials for use in the catalyst layers are described in more detail below.

in one or more examples, an OER catalyst layer may be provided at a side 114 of the first electrode facing the first plate 104. In one or more examples, an ORR catalyst layer may be provided at a side 115 of the first electrode facing the PEM 101.

in this and one or more examples, the first electrode 102 is porous and allows fluids to pass through the electrode to the PEM 101.

Suitable materials that may form the porous first electrode include a frit, foam, mesh or nonwoven of conductive material, preferably providing a tortuous path that allows the passage of fluids.

Suitable material for the first electrode include carbon cloth and metal frits,

The conductive material may be a metal, with metals having low reactivity being preferred. Suitable metals for the first electrode include titanium, vanadium, chromium, manganese, iron, cobalt, nickel and copper. Preferably, the metal for the first electrode includes titanium.

in one or more examples, the porous first electrode has a pore size between 5 and 100 μm, typically from 20 to 50 μm and preferably from 20 to 40 μm, most preferable from 30 to 35 μm.

The first electrode is typically coated with a hydrophobic material, which may protect the electrode from water which may be present in the fuel cell (and may perform other functions).

The one or more first catalyst layers are provided, in one or more examples, as a coating on the first electrode 102. However, in other examples, one or more of the one or more first catalyst layers 114, 115 may be provided as distinct layers separate from the first electrode 102 but arranged adjacent to the first electrode 102.

in this example, the OER first catalyst layer 114 comprises a coating on a side of the first electrode 102 facing the first end plate 104. In this example, the ORR first catalyst layer 115 comprises a coating on an opposed side of the first electrode 102 facing the PEM 101. In such an example, the first electrode 102 may be considered as an electrically conductive support material for said first catalyst layers 114, 115.

The fuel cell 100 may include one or more second catalyst layers 116, 117 between the second plate 105 and the polymer electrolyte membrane 101. The one or more second catalyst layers may be configured to provide an active site for catalytic activity for one or both of a hydrogen reduction reaction (HRR) and a hydrogen evolution reaction (HER).

in one or more examples, an HER catalyst layer may be provided at a side 116 of the second electrode facing the second plate 105. In one or more examples, an HRR catalyst layer may be provided at a side 117 of the second electrode facing the PEM 101.

Suitable catalytic materials for use as HER and HRR catalysts are described in more detail below.

The one or more second catalyst layers 116, 117 are provided, in one or more examples, as a coating on the second electrode 103.

However, in other examples, one or more of the one or more second catalyst layers 116, 117 may be provided as distinct layers separate from the second electrode 103 but arranged adjacent to the second electrode 103. In this example, the HER second catalyst layer 116 comprises a coating on a side of the second electrode 103 facing the second end plate 105. In this example, the HRR second catalyst layer 117 comprises a coating on an opposed side of the second electrode 103 facing the PEM 101. In such an example, the second electrode 103 may be considered as an electrically conductive support material for said second catalyst layers 116, 117.

The fuel cell 100 may optionally include a gas diffusion layer 118 between the PEM 101 and the second electrode 103. The gas diffusion layer may comprise a carbon based or carbon containing textile or cloth.

The gas diffusion layer 118 may be configured to provide for diffusion and distribution of fluid between the PEM 101 and the second electrode 103 or vice versa. This configuration minimises the risk of areas having higher concentration of fluid flux arising (so called ‘hot spots’), which can prolong the lifetime of the PEM 101 and/or the second electrode (103), or any storage material or catalytic layers associated with the second electrode.

in the present and one or more examples, the fuel cell 100 is configured to operate in a redox mode and a regenerative mode. In the redox mode the fuel cell 100 is configured to be provided with a fuel to the second electrode 103 and provided with an oxidant, such as oxygen from air, to the first electrode 102 to generate an electric current between the first and second electrodes 102, 103 and a reaction product at the first electrode 102. The fuel may be provided from a fuel source external to the fuel cell 100 and introduced via the fluid inlet of the second flow plate 105. Alternatively, or in addition, the fuel may be provided to the second electrode 103 from a fuel storage material.

in a hydrogen based fuel cell, the fuel comprises hydrogen, the oxidant comprises oxygen from air or an oxygen source, and the reaction product comprises water.

in the regenerative mode the fuel cell is configured to be provided with the reaction product, such as water in the case of a hydrogen based fuel cell, to the first electrode 102. A potential difference is to be provided between the first and second electrodes 102, 103 from an electrical power source (not shown) thereby generating said fuel, e.g., hydrogen, at the second electrode 103.

The fuel cell 100 may include a fuel storage material as part of or adjacent to the second electrode 103 to provide, at least in part, said fuel to the second electrode 103 in the redox mode and/or store, at least in part, said fuel generated at the second electrode 103 in the regenerative mode.

in this and one or more examples, the second electrode 103 is formed of said fuel storage material. Thus, the fuel storage material may be an integral part of the second electrode 103.

in other examples, the fuel storage material may comprise a distinct layer separate from the second electrode 103 but arranged adjacent to the second electrode 103 within the fuel cell 100 i.e., at least partly between the first and second plates 104, 105.

The fuel storage material may comprise a material that chemically and/or electrostatically stores hydrogen or hydrogen ions. Examples of such materials will be provided below.

in one or more examples, the PEM is bonded to a gas diffusion layer (such as a carbon based conductor, e.g., carbon paper, carbon cloth or carbon fibre, preferably carbon paper), with the other side of the gas diffusion layer being coated with HER catalyst. This catalytic layer is adjacent to the anode, allowing facile transfer of electrons.

This configuration has been found to be advantageous when the anode acts as a fuel storage material. In such configurations, the hydrogen evolved by the HER is also captured. If the HER is coated directly on the anode, it has been found that hotspots may occur leading to reduced efficiency of hydrogen storage.

in one or more embodiments, the fuel cell 100 includes a peripheral gasket 120 configured to be sandwiched between the first plate 104 and the second plate 105 and contain at least the polymer electrolyte membrane 101, the first electrode 102, the second electrode 103, the one or more first catalyst layers and the one or more second catalyst layers. The gasket 120 may be of silicone or vulcanized rubber. In other examples, the fuel cell 100 may be surrounded by a housing to contain said layers, the reactants and said reaction products.

in one or more examples, the fuel cell 100 may be part of a fuel cell stack 121 comprising a plurality of fuel cells arranged in series with one another. In FiG. 1, box 122 schematically represents an adjacent fuel cell to the fuel cell 100 in the fuel cell stack 121. The adjacent fuel cell 122 is substantially identical to fuel cell 100. Thus, in this example, the second plate 105 of the fuel cell 100 is electrically coupled with a first plate of the adjacent fuel cell 122 of the at least two fuel cells. In one or more examples, the electrically coupled first and second plates of the fuel cells of the stack 121 may be provided by a single plate, known as a bipolar plate. The bipolar plate may have the respective flow channels for the second electrode of one fuel cell of the fuel cell stack and the flow channels for the first electrode of the adjacent fuel cell 122 of the fuel cell stack. Thus, plate 105 may comprise a bipolar plate.

The first and second plates of the fuel cells of the stack 121, which may be provided in part by bipolar plates, may include an inlet manifold 124 running through the stack to deliver one or more of the fuel and the oxidant to the fuel cells therein. Likewise, the fuel cell stack 121 may include an outlet manifold 125 to receive fuel and/or oxidant and/or reaction product(s) from each of the fuel cells therein.

in use, in the redox mode, the fuel cell 100 (or the fuel cell stack 121) may be provided with a fuel, such as hydrogen from the fuel storage material of the second electrode 103 and/or from an external fuel source. The fuel from the external source may be flowed (such as by a pump) through the flow channels of the second plate 105. An oxidant, which may comprise air, in the redox mode, may be flowed through the flow channels of the first plate 105 (such as by a pump, not shown). With the reactants provided thereto, the first electrode 102 comprises the cathode and the second electrode 103 comprises the anode and an electrochemical reaction is provided by the fuel cell to generate a potential difference and thereby a flow of current between the first and second electrodes 102, 103 via an external circuit between the current tabs 112 and 113. The one or more second catalysts 117, 118 act to reduce the hydrogen fuel, wherein the proton passes through the PEM 101 while an electron passes through the external circuit. The proton and the oxidant for the reaction product at the first electrode 102. The one or more first catalysts 114, 115 may be provided to catalyse the formation of the reaction product.

Unused fuel on the “anode” side may be absorbed or captured by the hydrogen storage material and/or flow through the flow channels of the second plate 105 and out via a fuel outlet manifold, which may comprise a shared manifold 125. Unused oxidant and reaction product(s) such as water may flow through the flow channels of the first plate 104 and out via the outlet manifold 125.

in use, in the regenerative mode, the fuel cell 100 (or the fuel cell stack 121) may be provided with a reactant, which comprises the reaction product of water in the case of a hydrogen fuel cell. In one or more examples, the fuel cell may include a mist or vapour generator 123 to generate an atomized flow of reactant to the first electrode 102 via the flow channels of the first plate 104. The vapour generator 123 may comprise one of an ultrasound based vapour generator; a piezo-electric based vapour generator; or may comprise a pumped flow with an atomizing nozzle. In one or more examples, the flow of said reactant, which may comprise the reactant as a vapour, is unheated. Thus, while the vapour may be heated by the operation of the fuel cell, in one or more examples, no active heating of the reactant is provided.

in one or more examples, the flow of reactant is provided at a flow rate between 10 and 100 ml/minute per fuel cell 100. Preferably, the flow of reactant is provided at a flow rate between 10 to 90 ml/min per fuel cell 100, more preferably from 10 to 50 ml/min. Typically, the flow rate of reactant is provided at a flow rate of between 12 to 25 ml/min and preferably 15 to 20 ml/min per fuel cell. In one or more examples, the reactant is provided at a pressure between 1×10⁵ and 8×10⁵ Pa.

The fuel cells containing the catalytic materials disclosed herein are advantageous since they may operate at relatively low temperatures. Typical operating temperatures range from 60° C. to 85° C., preferably from 65° C. to 80° C.

These operating temperatures are usually achieved without any external influence, that is to say due to the device generating heat through exothermic reaction. Overheating is easily avoided by using cold water as the fuel source. Additional cooling means for the overall stack are optional, though usually not required.

Preferably, the fuel cell stack does not comprise any cooling elements such as fins or flow channels for coolant fluid which can remove heat from the fuel cell.

in the regenerative mode, a current flow is provided between the current tabs 112, 113. The current flow may be provided by the application of a DC potential difference between the first and second electrodes, via the current tabs 112,113. The one or more first catalyst layers 114, 115 may act to catalyse the reduction of the reactant, e.g. water. In the regenerative mode, with the reactant provided thereto, the first electrode 102 comprises the anode and the second electrode 103 comprises the cathode. The proton generated at the first electrode 102 may be stored in the fuel storage material of the second electrode 103. In one or more examples, any fuel not absorbed or captured by the fuel storage material may flow through the second electrode 103 and be received in the flow channels of the second plate 105, which may remove the unabsorbed fuel from the fuel cell 100. In other examples, the fluid inlet and fluid outlet to the flow channels of the second plate 105 may be closed and the fuel cell 100 may be configured to saturate the fuel storage material with fuel, such as hydrogen. In such an example, the flow channels of the second plate 105 may not be provided as no fuel is required to flow through them given that the fuel is provided by and absorbed by the fuel storage material. Unreacted reactant, such as water, may flow through the flow channels of the first plate 104 and out through an outlet.

FiG. 1 shows a fuel cell having that capability, by virtue of the provision of appropriate catalyst layers to operate in both a redox mode and a regenerative mode, as well as having an integral fuel storage material. However, in one or more examples only some of the above structures may be provided.

For example, in one or more examples, the fuel storage material may not be provided integral with the fuel cell 100. Instead, fuel generated in the regenerative mode may be provided to a fuel store external from the fuel cell 100 via the flow channels and outlet of the second plate 105. In an example embodiment, the one or more first catalysts 114, 115 and the one or more second catalysts 117, 116 may be provided but the second electrode 103 may comprise a material that does not act to store the fuel generated in the regenerative mode.

in a further example, the fuel cell 100 may be configured to include said fuel storage material but only operate in the redox mode. Thus, in one or more examples, only said catalyst(s) that act to promote said redox reaction may be provided. In a further example, the one or more first catalysts may not be provided and the one or more second catalysts may be provided. In such an example, the fuel storage material of the second electrode 103 may be “recharged” from an external fuel source rather than by operation in the regenerative mode. Thus, during “recharging”, gaseous hydrogen may be provided to the second electrode 105 via the flow channels of the second plate 105 and the one or more second catalyst layers 117, 116 may provide for reduction of said gaseous hydrogen to protons for storage in the fuel storage material.

in a further example, the fuel cell 100 may be configured to include said fuel storage material but only operate in the redox mode. It will be appreciated that the first and second catalyst layers act to improve the reaction rate of the fuel cell, but in some application, this may not be required. Thus, in one or more examples, the fuel cell 100 may include said fuel storage material but not one or more of said first and second catalyst layers 114, 115, 116, 117.

in a further example, the fuel cell 100 may be configured to only operate in the regenerative mode. Thus, the one or more first catalyst layers 114 may be provided but the one or more second catalyst layers 116, 117 may be absent. In such an example, the fuel storage material may or may not be provided. In the example where it is not provided, the fuel generated in the regenerative mode may be captured in a fuel store external to the fuel cell 100.

There will now be described examples of the one or more first catalyst layers 114, 115 and one or more methods of forming said layers. There will now be described examples of the one or more second catalyst layers 116, 117 and one or more methods of forming said layers. Further, there will be described one or more examples of the fuel storage material and one or more methods of forming said fuel storage material.

Some of the specific materials that may be used in the fuel cell are described in more detail below.

### (N-Doped) Carbon Nanofoam Material

The present disclosure provides an (N-doped) carbon nanofoam material having excellent properties as a component in redox catalysts in fuel cells.

As used herein, the term “(N-doped)” means the material is optionally N-doped. Thus, “(N-doped) carbon nanofoam material” denotes a carbon nanofoam material that may optionally be N-doped.

As used herein, “C_{nf}” may be used to denote a carbon nanofoam material.

As used herein, “C_{nf}-Nₓ” may be used to denote an N-doped carbon nanofoam material.

Carbon materials provide useful electrocatalysts due to their high surface area, high conductivity and cost. Various types of carbon materials suitable for use as electrocatalysts are disclosed in X. Wang et al., Adv. Energy Mater., 2017, 7, 1700544.

Non-metal atoms such as N, P, S and B can be doped into the carbon structure, resulting in multiple possible configurations of doped carbon material. Being more electronegative than carbon, these heteroatoms make neighbouring carbon atoms electron deficient, thereby promoting oxygen adsorption on the carbon nanostructure. Doped carbon structures may take various forms, including nanotubes, sheets or particulate carbon materials.

Of these doping atoms, N is advantageous as it provides a stable material having the desired balance of properties. Specifically, the N-doping provides faster electron transfer, decreased bulk resistance and increased coupling efficiency when the material is modified by a catalytic metal. In contrast, doping with S and P typically acidifies the carbon leading to a material with higher pH sensitivity. Modification with S typically leaves a carbon material having a highly reactive surface, which can lead to poorer lifetime and side reactions occurring.

The (N-doped) carbon nanofoam material of the present disclosure may be characterised as a superstructure of coalesced (N-doped) carbon nanofoam particles, said particles having a diameter of from 0.005 μm to 25 μm.

Preferably, the nanofoam particles are from 0.01 to 15 μm, preferably from 0.01 to 5 μm, more preferably from 0.01 to 2 μm in diameter.

The diameters of the nanofoam particles may be measured by SEM. Typically, in such a process the largest dimension of the particle is measured.

The average diameter may be calculated by taking the mean value of the measurement of the largest dimension of ten separate nanofoam particles.

in an example, the (N-doped) carbon nanofoam material has a superstructure of coalesced (N-doped) carbon nanofoam particles, said superstructure having a tortuous path of open pores at least 3 times the average diameter of the nanofoam particles, preferably at least 5 times the average diameter of the nanofoam particles, for instance from 5 to 100 times, preferably from 5 to 50 times the average diameter of the nanofoam particles.

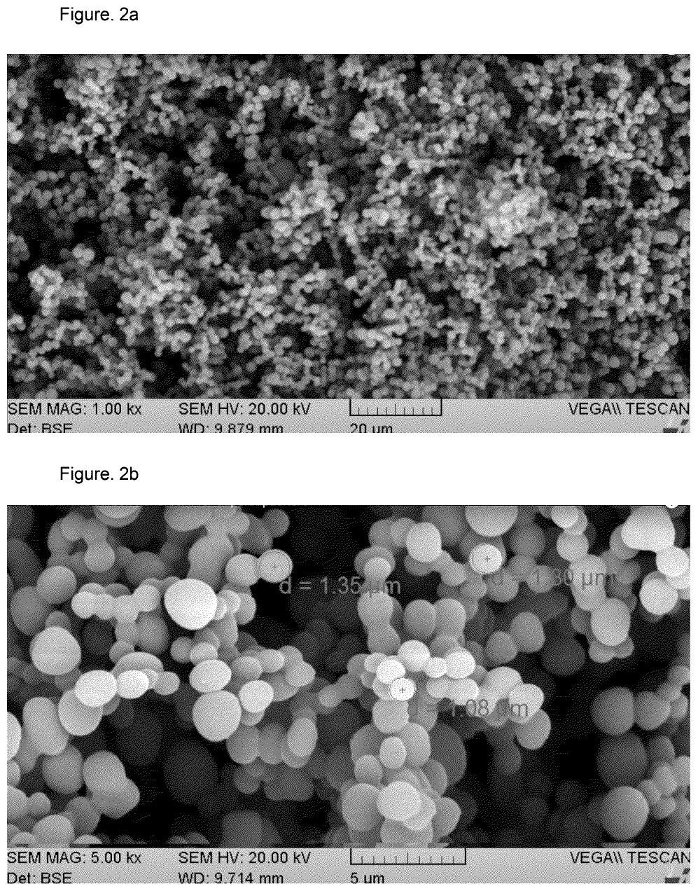

The open pores typically have an irregular shape, as shown in FiG. 2b. The pore size can be determined by SEM, with the average size of any given pore being defined as the mean of the largest and smallest dimension of that pore as determined by SEM.

The average size of the pores of the super structure will vary depending on the size of the particles of the nanofoam particles, and are typically from 10 to 100 μm, such as for nanofoam particles being around 1 μm.

in an alternative embodiment, the average size of the pores of the super structure are typically from 0.2 to 2 μm.

The mean pore size can be determined by the mean of 10 average pore sizes, as determined by SEM.

in an example, the (N-doped) carbon nanofoam material has a density of below 300 mg/cm³, typically from 50 to 200 mg/cm³ and preferably from 50 to 150 mg/cm³.

The density of the (N-doped) carbon nanofoam material may be measured by weighing the bulk material and then correlating for the mass of the average element density.

Methods for making carbon nanofoams are known in the art, for instance in Sattler et al., Carbon 95 (2015), pp434-441.

An example method of forming an (N-doped) carbon nanofoam material comprises:
i. forming a mixture of sugar, water and hydrocarbon mediator;
ii. heating said mixture to form a carbon nanofoam; and
iii. optionally heating the carbon nanofoam in an acidic nitrogen source (e.g. nitric acid) to form an N-doped carbon nanofoam.

Suitable sugars to use include monosaccharides, disaccharides and trisaccharides, for instance sucrose, glucose or fructose, with sucrose being preferred.

The mixture of sugar and water is highly concentrated, namely at least 3 molar, typically at least 4 molar such as about 5 molar. Such high concentrations will typically require heating and vigorous stirring to fully dissolve the sugar, typically from 50° C. to 85° C., for instance from 60° C. to 80° C.

Typically, the concentrated sugar solution is cooled before the hydrocarbon mediator is added, for instance cooled to below 50° C.

Suitable hydrocarbon mediators include aromatic hydrocarbons such as pyrene, chrysene, benz[a]anthracene, fluoranthene, anthracene, naphthalene, benzene and hexane, with anthracene, naphthalene and benzene being preferred and naphthalene being most preferred.

Typically, only a small amount of hydrocarbon mediator (e.g., naphthalene) is required. For instance, the ratio of hydrocarbon mediator (e.g., naphthalene) to sugar (e.g., sucrose) is typically from 1:25,000 to 1:75,000, or 1:50,000 to 1:65,000.

Step ii requires heating the mixture to form a nanofoam. The mixture is heated at a temperature and for a time sufficient to carbonise the sugar to form a particulate material.

Suitably, the mixture is heated at a temperature of from 100° C. to 600° C. for 30 minutes to 24 hours. Heating to a higher temperature usually requires a shorter heating time. For instance, the mixture may be heated to 500° C. for 1 hour. Alternatively, the mixture may be heated to 155° C. for 5 hours. Heating the mixture for longer is of course possible, but this is usually not required.

Preferably, the mixture is heated at a temperature of from 350° C. to 600° C. for 30 minutes to 3 hours. Alternatively, the mixture is heated at a temperature of from 100° C. to 300° C. for 4 hours to 12 hours.

The heating step carbonises the material to form a nanofoam. As such, the heating is typically carried out in a suitably inert vessel, for instance a Teflon coated hydrothermal reactor.

The heating step is preferably carried out in a sealed reactor.

The resultant nanofoam may optionally be comminuted, for instance by milling. Milling may be carried out in a ball mill.

The resultant material is a superstructure of coalesced carbon nanofoam particles. The carbon nanofoam particles are typically mesoporous, i.e., having pores of 2 nm to 50 nm. The nanofoam particles are bound together by covalent interactions, resulting in a superstructure that is surprisingly retained even under mechanical stresses such as during milling.

The pore size of the mesopores may be determined by tunnelling electron microscopy. In such a process, the material may be coated with a metal such as titanium by sputtering. After coating, the pore structure can be observed using a tunnelling electron microscope, with the pore size being determinable from the image produced.

Although the methodology provides an image of the surface, it is evident from the bulk reactivity of the material that the pores extend beneath the surface into the structure of the carbon. The material is therefore best described as a mesoporous carbon nanofoam.

The nanofoam particles may vary in shape, and the shape can be dependent on the sugar and hydrocarbon mediator that are used. For instance, glucose and naphthalene form cube-like structures.

Sucrose and naphthalene are preferred and give rise to approximately spherical particles.

The nanofoam particles are typically from 0.01 to 15 μm, preferably from 0.01 to 5 μm, more preferably from 0.01 to 2 μm in diameter.

Step iii. comprises N-doping by heating the carbon nanofoam with an acidic nitrogen source, such as nitric acid (HNO₃), nitrous acid (HNO), hyponitrous acid (H₂N₂O) or mixtures thereof, with nitric acid being preferred.

Typically, the carbon nanofoam is heated to at least 80° C. for at least 2 hours, for instance to at least 90° C. for at least 4 hours, preferably 95° C. to 115° C. for at least 4 hours.

The heating is typically carried out in a suitable acid resistant pressure vessel, for instance a Teflon hydrothermal reactor.

The acidic nitrogen source (e.g. nitric acid) should be sufficiently concentrated to ensure sufficient levels of N-doping. Suitable concentrations (e.g. of nitric acid) include from 3 molar to 10 molar, preferably from 4 molar to 8 molar.

Treatment of the carbon nanoparticles with nitric acid or an alternative acidic nitrogen source introduces N-doping into the structure, forming a mixture of pyridinic-N, pyrrolic-N and graphitic-N sites. However, when nitric acid, or an alternative acidic nitrogen source is used, the acid conditions additionally form carboxylate groups at the surface of the material. Moreover, pitting of the surface can occur, resulting in loss of some of the mesoporous structure. The conditions therefore need to be controlled to provide the desired amount of doping while avoiding too much degradation of the mesoporous structure. The process is however mild enough to ensure that the superstructure of coalesced particles is retained.

Typically, the surface pore sizes are around 2 to 10% larger after treatment with nitric acid, or alternative acidic nitrogen source.

Typically, the resultant material has an N content of from 0.1 to 8 wt %, preferably from 1 to 5 wt %.

The surface area of the resultant material is typically from 200 to 3500 m²/g, preferably 400-3000 m²/g, preferably 1000 to 2500 m²/g, preferably 1000-2000 m²/g. For example, 1000-1800 m²/g, preferably 1200-1800 m²/g, preferably 1200-1600 m²/g.

The surface area may be measured by BET isotherm, for instance at 77 K using nitrogen.

The above process is an exemplary way of forming the N-doped carbon nanofoam. Alternative methods are possible. For instance, the mesoporous structure is obtained by heating the mixture of sugar, water and hydrocarbon mediator. If a nitrogen source is included in the mixture, this can lead to an N-doped carbon nanofoam being formed without the need for step iii (treatment with the acidic nitrogen source).

### Electrically Conductive Polymer

By “electrically conductive polymer” is meant a polymer that will form a film which has a conductivity greater than 10⁻⁷ S/cm.

The electrically conductive polymers suitable for the catalyst layers are made from at least one monomer which, when polymerized alone, forms an electrically conductive homopolymer. Such monomers are referred to herein as “conductive precursor monomers.” Monomers which, when polymerized alone form homopolymers which are not electrically conductive, are referred to as “non-conductive precursor monomers.”

The conductive polymer can be a homopolymer or a copolymer. Conductive copolymers suitable for the catalyst layer can be made from two or more conductive precursor monomers or from a combination of one or more conductive precursor monomers and one or more non-conductive precursor monomers.

in some embodiments, the electrically conductive polymer is made from at least one conductive precursor monomer selected from thiophenes, selenophenes, tellurophenes, pyrroles, anilines, and polycyclic aromatics. The polymers made from these monomers are referred to herein as polythiophenes, poly(selenophenes), poly(tellurophenes), polypyrroles, polyanilines, and polycyclic aromatic polymers, respectively.

Preferably, the electrically conductive polymer is a poly-N-aryl polymer.

The term “poly-N-aryl” refers to a polymer made up of monomers having N-heteroaromatic rings such as pyrrole, indole or the like, and/or monomers having an amine substituted aromatic ring such as aniline, 1-naphthyl amine or the like.

The term “polycyclic aromatic” refers to compounds having more than one aromatic ring. The rings may be joined by one or more bonds, or they may be fused together.

The term “aromatic ring” is intended to include heteroaromatic rings. A “polycyclic heteroaromatic” compound has at least one heteroaromatic ring.

in some embodiments, pyrrole monomers contemplated for use to form the electrically conductive polymer in the new composition comprise Formula ii below.

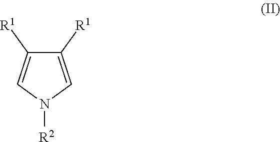

where in Formula ii:
R¹ is independently selected so as to be the same or different at each occurrence and is selected from hydrogen, alkyl, alkenyl, alkoxy, alkanoyl, aryloxy, alkylaryl, arylalkyl, amino, alkylamino, dialkylamino, aryl, alkoxyalkyl, alkoxycarbonyl, acrylic acid, phosphoric acid, phosphonic acid, halogen, nitro, cyano, hydroxyl, epoxy, silane, siloxane, alcohol, benzyl, carboxylate, ether, ether carboxylate, and urethane; or
both R¹ groups together may form an alkylene or alkenylene chain completing a 3, 4, 5, 6, or 7-membered aromatic or alicyclic ring, which ring may optionally include one or more divalent nitrogen, or oxygen atoms; and
R² is independently selected so as to be the same or different at each occurrence and is selected from hydrogen, alkyl, alkenyl, aryl, alkanoyl, alkylaryl, arylalkyl, amino, epoxy, silane, siloxane, alcohol, benzyl, carboxylate, ether, ether carboxylate, and urethane.

As used herein, the term “alkyl” refers to a group derived from an aliphatic hydrocarbon and includes linear, branched and cyclic groups which may be unsubstituted or substituted.

The term “heteroalkyl” is intended to mean an alkyl group, wherein one or more of the carbon atoms within the alkyl group has been replaced by another atom, such as nitrogen, oxygen, and the like.

The term “alkylene” refers to an alkyl group having two points of attachment.

As used herein, the term “alkenyl” refers to a group derived from an aliphatic hydrocarbon having at least one carbon-carbon double bond, and includes linear, branched and cyclic groups which may be unsubstituted or substituted. The term “heteroalkenyl” is intended to mean an alkenyl group, wherein one or more of the carbon atoms within the alkenyl group has been replaced by another atom, such as nitrogen, oxygen, and the like.

The term “alkenylene” refers to an alkenyl group having two points of attachment.

As used herein, the following terms for substituent groups refer to the formulae given below:

| | |
|---|---|
| “alcohol” | —R³—OH |
| “amido” | —R³—C(O)N(R⁶) R⁶ |
| “benzyl” | —CH₂•C₆H₅ |
| “carboxylate” | —R³—C(O)O—Z or —R³—O—C(O)—Z |
| “ether” | —R³—(O—R⁵)P—O—R⁵ |
| “ether carboxylate” | —R³—O—R⁴—C(O)O—Z or —R³—O—F |
| “urethane” | —R³—O—C(O)—N(R⁶)₂ |

where all “R” groups are the same or different at each occurrence and:
R³ is a single bond or an alkylene group
R⁴ is an alkylene group
R⁵ is an alkyl group
R⁶ is hydrogen or an alkyl group
p is 0 or an integer from 1 to 20
Z is H, alkali metal, alkaline earth metal, N(R⁵)₄ or R⁵

Any of the above groups may further be unsubstituted or substituted, and any group may have F substituted for one or more hydrogens, including perfluorinated groups. in some embodiments, the alkyl and alkylene groups have from 1-20 carbon atoms, preferably from 1-4 carbon atoms.

in some embodiments, R¹ is the same or different at each occurrence and is independently selected from hydrogen, alkyl, alkenyl, alkoxy, cycloalkyl, cycloalkenyl, alcohol, benzyl, carboxylate, ether, ether carboxylate, urethane, epoxy, silane, siloxane, and alkyl substituted with one or more of carboxylic acid, acrylic acid, phosphoric acid, phosphonic acid, halogen, nitro, cyano, hydroxyl, epoxy, silane, or siloxane moieties. In some embodiments, R² is selected from hydrogen, alkyl, and alkyl substituted with one or more of carboxylic acid, acrylic acid, phosphoric acid, phosphonic acid, halogen, cyano, hydroxyl, epoxy, silane, or siloxane moieties.

Preferably, the pyrrole monomer is unsubstituted and both R¹ and R² are hydrogen.

in some embodiments, both R¹ together form a 6- or 7-membered alicyclic ring, which is further substituted with a group selected from alkyl, heteroalkyl, alcohol, benzyl, carboxylate, ether, ether carboxylate, and urethane. These groups can improve the solubility of the monomer and the resulting polymer.

in some embodiments, both R¹ together form a 6- or 7-membered alicyclic ring, which is further substituted with an alkyl group. In some embodiments, both R¹ together form a 6- or 7-membered alicyclic ring, which is further substituted with an alkyl group having at least 1 carbon atom.

in some embodiments, both R¹ together form —O—(CHY)ₘ—O—, where m is 2 or 3, and Y is the same or different at each occurrence and is selected from hydrogen, alkyl, alcohol, benzyl, carboxylate, ether, ether carboxylate, and urethane.

in some embodiments, at least one Y group is not hydrogen.

in some embodiments, at least one Y group is a substituent having F substituted for at least one hydrogen. In some embodiments, at least one Y group is perfluorinated.

in some embodiments, aniline monomers contemplated for use to form the electrically conductive polymer in the new composition comprise Formula iii below.

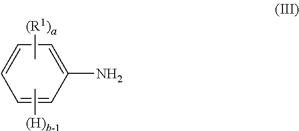

wherein:
a is 0 or an integer from 1 to 4;
b is an integer from 1 to 5, with the proviso that a+b=5; and
R¹ is independently selected so as to be the same or different at each occurrence and is selected from hydrogen, alkyl, alkenyl, alkoxy, alkanoyl, aryloxy, alkylaryl, arylalkyl, amino, alkylamino, dialkylamino, aryl, alkoxyalkyl, alkoxycarbonyl, acrylic acid, phosphoric acid, phosphonic acid, halogen, nitro, cyano, hydroxyl, epoxy, silane, siloxane, alcohol, benzyl, carboxylate, ether, ether carboxylate, and urethane; or
both R¹ groups together may form an alkylene or alkenylene chain completing a 3, 4, 5, 6, or 7-membered aromatic or alicyclic ring, which ring may optionally include one or more divalent nitrogen, or oxygen atoms.

When polymerized, the aniline monomeric unit can have Formula iV(a) or Formula iV(b) shown below, or a combination of both formulae:

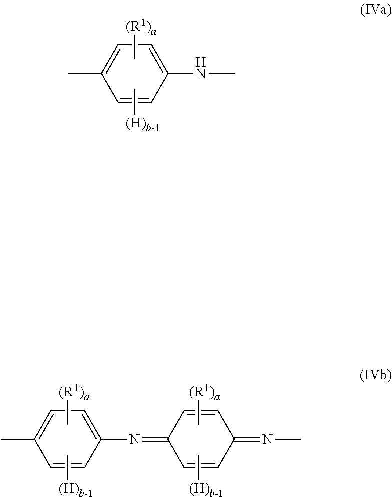

where
a, b and R¹ are as defined above.

in some embodiments, the aniline monomer is unsubstituted and a=0.

in some embodiments, a is not 0 and at least one R¹ is fluorinated. In some embodiments, at least one R¹ is perfluorinated.

in some embodiments, fused polycyclic heteroaromatic monomers contemplated for use to form the electrically conductive polymer in the new composition have two or more fused aromatic rings, at least one of which is heteroaromatic.

in some embodiments, the fused polycyclic heteroaromatic monomer has Formula V:

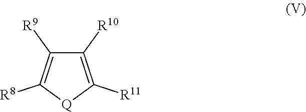

wherein:
Q is NR⁶;
R⁶ is hydrogen or alkyl;
R⁸, R⁹, R¹⁰, and R¹¹ are independently selected so as to be the same or different at each occurrence and are selected from hydrogen, alkyl, alkenyl, alkoxy, alkanoyl, aryloxy, alkylaryl, arylalkyl, amino, alkylamino, dialkylamino, aryl, alkoxyalkyl, alkoxycarbonyl, acrylic acid, phosphoric acid, phosphonic acid, halogen, nitro, nitrile, cyano, hydroxyl, epoxy, silane, siloxane, alcohol, benzyl, carboxylate, ether, ether carboxylate, and urethane; and
at least one of R⁸ and R⁹, R⁹ and R¹⁰, and R¹⁰ and R¹¹ together form an alkenylene chain completing a 5 or 6-membered aromatic ring, which ring may optionally include one or more divalent nitrogen, or oxygen atoms.

in some embodiments, the fused polycyclic heteroaromatic monomer has a formula selected from the group consisting of Formula V(a), V(b), V(C), V(d), V(e), V(f), V(g), V(h), V(i), VG), and V(k);

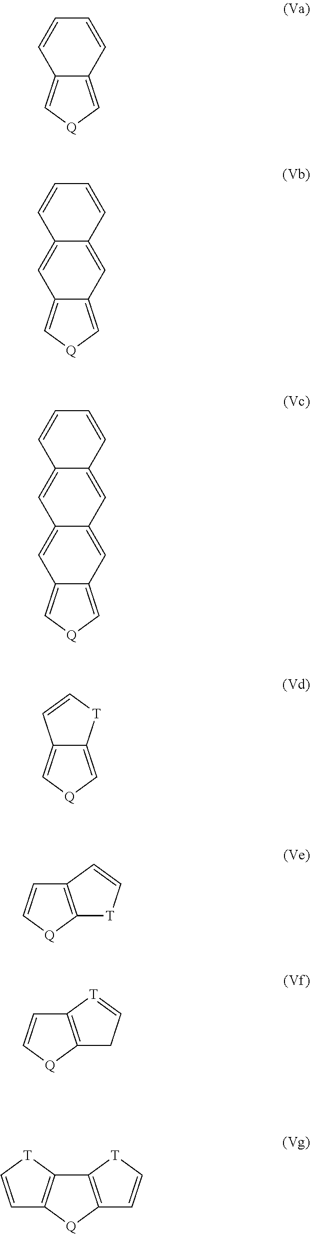

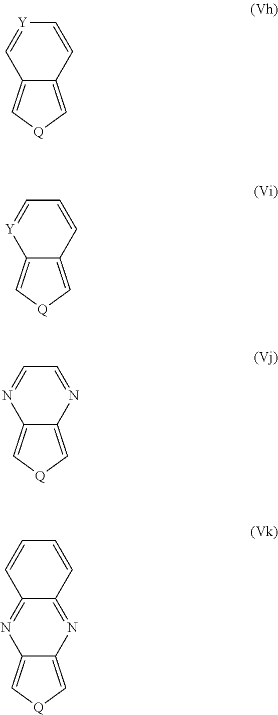

wherein:
Q is NH; and
T is the same or different at each occurrence and is selected from NR⁶, O, SiR⁶₂, and PR⁶;
Y is N; and
R⁶ is hydrogen or alkyl.

The fused polycyclic heteroaromatic monomers may be further substituted with groups selected from alkyl, heteroalkyl, alcohol, benzyl, carboxylate, ether, ether carboxylate, and urethane. In some embodiments, the substituent groups are fluorinated. In some embodiments, the substituent groups are fully fluorinated.

in some embodiments, polycyclic heteroaromatic monomers contemplated for use to form the polymer in the new composition comprise Formula Vi:

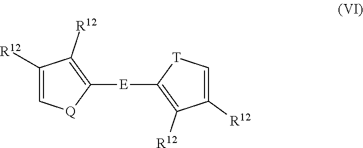

wherein:
Q is NR⁶;
T is selected from NR⁶, O, SiR⁶₂, and PR⁶;
E is selected from alkenylene, arylene, and heteroarylene;
R⁶ is hydrogen or alkyl;
R¹² is the same or different at each occurrence and is selected from hydrogen, alkyl, alkenyl, alkoxy, alkanoyl, aryloxy, alkylaryl, arylalkyl, amino, alkylamino, dialkylamino, aryl, alkoxyalkyl, arylsulfinyl, alkoxycarbonyl, arylsulfonyl, acrylic acid, phosphoric acid, phosphonic acid, halogen, nitro, nitrile, cyano, hydroxyl, epoxy, silane, siloxane, alcohol, benzyl, carboxylate, ether, ether carboxylate, and urethane; or
both R¹² groups together may form an alkylene or alkenylene chain completing a 3, 4, 5, 6, or 7-membered aromatic or alicyclic ring, which ring may optionally include one or more divalent nitrogen, or oxygen atoms.

in some embodiments, the electrically conductive polymer is a copolymer of a precursor monomer and at least one second monomer. Any type of second monomer can be used, so long as it does not detrimentally affect the desired properties of the copolymer. In some embodiments, the second monomer comprises no more than 50% of the polymer, based on the total number of monomer units. In some embodiments, the second monomer comprises no more than 30%, based on the total number of monomer units. In some embodiments, the second monomer comprises no more than 10%, based on the total number of monomer units.

Exemplary types of second monomers include, but are not limited to, alkenyl, alkynyl, arylene, and heteroarylene. Examples of second monomers include, but are not limited to, fluorene, oxadiazole, phenylenevinylene, phenyleneethynylene, pyridine, diazines, and triazines, all of which may be further substituted.

in some embodiments, the copolymers are made by first forming an intermediate precursor monomer having the structure A-B-C, where A and C represent precursor monomers, which can be the same or different, and B represents a second monomer. The A-B-C intermediate precursor monomer can be prepared using standard synthetic organic techniques, such as Yamamoto, Stille, Grignard metathesis, Suzuki, and Negishi couplings. The copolymer is then formed by oxidative polymerization of the intermediate precursor monomer alone, or with one or more additional precursor monomers.

The electrically conductive polymer is typically formed by oxidative polymerization of the precursor monomer in the presence of an acid.

The acid is preferably a sulphonic acid, a carboxylic acid, or mixtures thereof, with sulphonic acids being particularly preferred.

The acid may be a polymeric acid selected from polymeric sulfonic acid, polymeric phosphoric acid, polymeric phosphonic acid, polymeric carboxylic acid, polymeric acrylic acid, or mixtures thereof.

Suitable polymeric acids include polymeric styrene sulfonic acid.

The polymeric acid may be fluorinated, and may be a fluorinated acid polymer as described herein.

The acid may also be non-polymeric and selected from a sulfonic acid, a carboxylic acid acid, or mixtures thereof.

Suitable non-polymeric acids include aromatic sulphonic acids, aromatic carboxylic acids, and mixtures thereof, with aromatic sulphonic acids being particularly preferred.

Suitable aromatic sulphonic acids include benzene sulphonic acid or toluene sulphonic acid.

Preferably, the electrically conductive polymer is formed in the presence of toluene sulphonic acid.

### OER, ORR, HER, HRR Catalytic Materials

Various types of catalytic materials are known for use in fuel cells. For instance, X. Wang et al., Adv. Energy Mater., 2017, 7, 1700544 and C. Zhang et al., Front. Energy., 2017, 11, 268-285 and N. Alonso-Vante et al., catalysts, 2018, 8, 559 provide an overview.

in some embodiments, a bifunctional catalyst may be used in the fuel cell. Bifunctional catalysts are catalysts that have the ability to catalyse two different types of reactions.

in some instances, the ORR and the OER may be catalysed by the same bifunctional catalyst.

in some instances, the OER and HER may be catalysed by the same bifunctional catalyst.

in instances where a bifunctional catalyst is used, a heterojunction may be employed to separate the positive and negative charges in an organic material.

Noble metal-based electrocatalysts (Pt, ir and Ru-based) are well-known to catalyse ORR, OER and HER reactions.

Platinum group metals are known for use as electrocatalysts and the most commonly used in electrocatalysis platinum. However, due to concerns with durability platinum usage worldwide, research has been done into new platinum group metal alloy nanoparticles supported on a conductive substrate, such as, carbon, carbon black, oxides, single-walled carbon nanotubes and carbon nanofibers.

Such platinum group metal alloys can be described as Pt-M (wherein M=3d transition metal) alloy nanoparticles. For example, wherein M is one or more of Ni, Co, Fe, Cu, Pd, Rh, TI, V, Cr, Mo, W and Re. For example, PtNi₃, PtₓCo (wherein x=2, 3, 5, 7 and 9), Pt₃Cu, PtCu and PtCu₃.

in some instances, ternary Pt-based systems may also be suitable catalysts. For example, catalysts that may be described as Pt-M-N, wherein M is as defined as above and N is Fe, Cu, Ni or Co. For instance, Pt₂CuNi, Pt₃CoNi, Pt₃FeNi and Pt₃FeCo.

Transition metal-based catalysts are also known as suitable electrocatalysts for ORR, OER and HER. For example, TI, V, Mn, Fe, Ru, Co, Rh, ir, Ni, Pd, Pt, or mixtures thereof based catalysts such as Mn, Co, Ni and Fe oxides.

Suitable cobalt based catalysts include, but are not limited to, cobalt oxide, cobalt phosphides, cobalt halides, cobalt nitrates, cobalt chalcogenides (sulphide and selenides), Co-included layered double hydroxides, Co—N—C, Co-based single atoms, Co-MOFs (metal organic frameworks), cobalt carboxylates, Co-Nx/C and their composites.

Examples of cobalt sulphides include CoS, CoS₂, Co₉S₈ and Co₃S₄.

Examples of cobalt oxides include Co₃O₄ and CoO.

Examples of cobalt phosphides include CoP, Co₂P and Co₃P₂.

Examples of cobalt carboxylates include cobalt acetate and cobalt oxalate.

Preferred cobalt salts have a crystallite size below 0.7 nm, preferably below 0.6 nm.

Such cobalt salts include cobalt nitrate, cobalt chloride, cobalt oxalate, and cobalt acetate. Cobalt nitrate and cobalt acetate have a crystalline size below 0.6 nm and are preferred, with cobalt acetate being particularly preferred.

Such cobalt materials may be mixed, doped or combined with other materials, such as carbon materials.

Catalytic metals can be supported on a conductive substrate, for example, supported onto conducting carbonaceous materials such as carbon black, Vulcan-XC-72, nitrogen-doped carbon nanotubes, carbon nanowebs, graphene and reduced graphene oxides.

Catalytic metals supported on an (N-doped) carbon nanofoam material according to the disclosure have been developed and form part of the composite catalytic material disclosed herein.

in some instances, cobalt phosphide (CoP) nanoparticles embedded in amorphous cobalt oxides (CoOx) nanoplates with heterojunction-like structure (Cop@a-CoOx plate) may be used.

in such instances, the Cop@a-CoOx plate may be synthesised via combined solvothermal and low temperature phosphidation route. Such methods are known in the art.

For instance, the CoP@a-CoOx plate may be synthesised from a CoCo layered double hydroxide precursor (CoCo-LDH plate).

A CoCo-LDH plate may be prepared via a solvothermal route. For instance, a cobalt salt such as cobalt acetate may be added to a suitable solvent such as ethylene glycol, if necessary being dissolved by ultrasonification. The solution may then be heated for a sufficient time then allowed to cool, for instance heating at around 200° C. for around 5 hours then cooling to room temperature. The resultant precipitate may be recovered, for instance by suction filtration and rinsing with deionised water and ethanol. The subsequent filtrate may then be dried, for instance at 60° C. overnight/around 12 hours.

The CoCo-LDH may then be phosphidated using the phosphorous vapor, for instance from sodium hypophosphite (NaH₂PO₂). In an exemplary method, the CoCO-LDH may be introduced into a tube reactor with NaH₂PO₂ in a mass ratio of NaH₂PO₂:CoCo-LDH 10:1, under an argon atmosphere and then heated to 300° C. using a ramping rate of 1° C./min in a static argon atmosphere. The heating at 300° C. may be maintained for 1 hour.

The skilled person will understand that the above described catalysts can possess different morphologies. The catalysts may be microstructures, such as microparticles or nanostructures such as nanoparticles, nanospheres, nanowires, nanosheets, nano-rods, core-shell and hollow structures.

By the term “nanostructure” as used herein, this refers to a structure having at least one dimension of 1000 nm or smaller, preferably all three dimensions are 1000 nm or smaller.

in another embodiment the nanostructure has an average size of from about 1 nm to about 200 nm.

in some instances, the nanostructure has an average size of from about 20 nm to about 100 nm, from about 30 nm to about 80 nm or from about 30 nm to about 50 nm.

The skilled person will understand that the term nanostructure average size, as used herein, will refer to the diameter of the nanostructure at the greatest point thereof, which may be measured using techniques well-known to those skilled in the art, for example using electron microscopy techniques (such as by Scanning Electron Microscopy (SEM) or Transmission Electron Microscopy (TEM), or dynamic light scattering (DLS) technique known to those skilled in the art).

Preferably the catalytic material facilitates a four-electron oxygen reduction reaction.

When reducing oxygen in an acidic environment, there are two potential pathways; the four-electron pathway, or the two-electron pathway which comprises two two-electron steps. A schematic of the two pathways is shown below.

Four-electron pathway:

O₂+4H⁺+4e⁻→2H₂O

Two-electron pathway:

O₂+2H⁺+2e⁻→H₂O₂

H₂O₂+2H⁺+2e⁻→2H₂O

As shown in the above reaction schemes, hydrogen peroxide (H₂O₂) is an intermediate of the two-electron pathway. Hydrogen peroxide can degrade the fuel cell materials, limiting the efficiency and lifetime. In particular, the membrane is particularly sensitive to the presence of hydrogen peroxide in the system.

it is therefore preferable to provide a catalyst that favours a direct (one-step) four-electron reduction reaction in order to minimize the amount of hydrogen peroxide produced.

Examples of catalyst materials that promote the direct four-electron pathway are Co, Fe and Ni-based catalyst materials, for example metallic Co, Fe, Ni; alloys of Co, Fe, Ni; oxides of Co, Fe, Ni; or mixtures thereof, wherein preferably, when present, Fe is in a 3+oxidation state.

Preferred catalyst materials that promote the direct four-electron pathway are selected from Co, Ni—Fe alloys, NiOz, or mixtures thereof.

### Fluorinated Acid Polymer

The fluorinated acid polymer can be any polymer which is fluorinated and has acidic groups with acidic protons. The acidic groups supply an lonizable proton. In some embodiments, the acidic proton has a pka of less than 3. In some embodiments, the acidic proton has a pka of less than 0. In some embodiments, the acidic proton has a pka of less than −5.

The acidic group can be attached directly to the polymer backbone, or it can be attached to side chains on the polymer backbone.

Examples of acidic groups include, but are not limited to, carboxylic acid groups, sulfonic acid groups, sulfonimide groups, phosphoric acid groups, phosphonic acid groups, and combinations thereof. The acidic groups can all be the same, or the polymer may have more than one type of acidic group.

in some embodiments, the acidic groups are selected from the group consisting of sulfonic acid groups, sulfonimide groups, and combinations thereof.

in some embodiments, fluorinated acid polymer has at least about 50% of the total number of halogen and hydrogen atoms in the polymer being fluorine atoms, typically at least about 75%, and preferably at least about 90%.

Fluorinated acid polymers having at least about 90% of the total number of halogen and hydrogen atoms in the polymer being fluorine atoms are described as “highly fluorinated”.

Preferably, the fluorinated acid polymer is perfluorinated.

Examples of suitable polymeric backbones include, but are not limited to, polyolefins, polyacrylates, polymethacrylates, polyimides, polyamides, polyaramids, polyacrylamides, polystyrenes, and copolymers thereof, all of which are typically highly-fluorinated; and preferably fully-fluorinated.

in one embodiment, the acidic groups are sulfonic acid groups or sulfonimide groups.

A sulfonimide group has the formula:

—SO₂—NH—SO₂—R

where R is an alkyl group.

in some embodiments, the acidic groups are on a fluorinated side chain. Fluorinated side chains may be selected from alkyl groups, alkoxy groups, amido groups, ether groups, and combinations thereof, all of which are preferably fully fluorinated.

in some embodiments, the fluorinated acid polymer has a highly-fluorinated olefin backbone, with pendant highly-fluorinated alkyl sulfonate, highly-fluorinated ether sulfonate, highly-fluorinated ester sulfonate, or highly-fluorinated ether sulfonimide groups.

in some embodiments, the fluorinated acid polymer is a perfluoroolefin having perfluoro-ether-sulfonic acid side chains.

in some embodiment, the polymer is a copolymer of 1,1-difluoroethylene and 2-(1,1-difluoro-2-(trifluoromethyl) allyloxy)-1,1,2,2-tetrafluoroethanesulfonic acid,

in some embodiments, the polymer is a copolymer of ethylene and 2-(2-(1,2,2-trifluorovinyloxy)-1,1,2,3,3,3-hexafluoropropoxy)-1,1,2,2-tetrafluoroethanesulfonic acid. These copolymers can be made as the corresponding sulfonyl fluoride polymer and then can be converted to the sulfonic acid form.

in some embodiments, the fluorinated acid polymer is homopolymer or copolymer of a fluorinated and partially sulfonated poly(arylene ether sulfone). The copolymer can be a block copolymer.

in one embodiment, the fluorinated acid polymer is a sulfonimide polymer having Formula Vii:

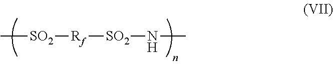

where:
R_{f} is selected from highly-fluorinated alkylene, highly-fluorinated heteroalkylene, highly-fluorinated arylene, and highly-fluorinated heteroarylene, which may be substituted with one or more ether oxygens; and
n is at least 4.

in some embodiments of Formula Vii, Rr is a perfluoroalkyl group such as a perfluorobutyl group.

in some embodiments, Rr contains ether oxygens.

in some embodiments, n is greater than 10.

in one embodiment, the fluorinated acid polymer comprises a highly-fluorinated polymer backbone and a side chain having Formula Viii:

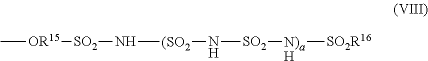

where:
R¹⁵ is a highly-fluorinated alkylene group or a highly-fluorinated heteroalkylene group;
R¹⁶ is a highly-fluorinated alkyl or a highly-fluorinated aryl group; and
a is 0 or an integer from 1 to 4.

in one embodiment, the fluorinated acid polymer has Formula iX:

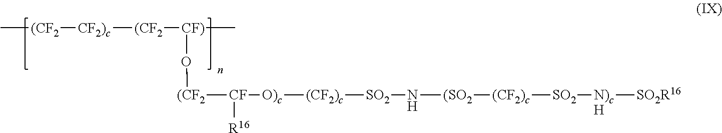

where
each R¹⁶ is independently a highly-fluorinated alkyl or a highly-fluorinated aryl group;
each c is independently 0 or an integer from 1 to 3; and
n is at least 4.

in one embodiment, the fluorinated acid polymer has Formula X:

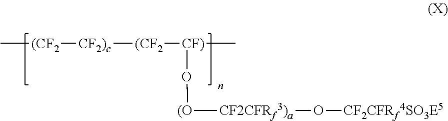

where
each c is independently 0 or an integer from 1 to 3;
n is at least 4;
R_{f}³ and R_{f}⁴ are independently selected from F, Cl or a highly-fluorinated alkyl group having 1 to 10 carbon atoms,
a=0, 1 or 2, and
E⁵ is selected from hydrogen or a cation such as Li, Na, or K.

in one embodiment, the fluorinated acid polymer has formula Xi:

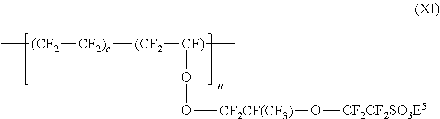

where
each c is independently 0 or an integer from 1 to 3;
n is at least 4; and
E⁵ is selected from hydrogen or a cation such as Li, Na, or K.

The synthesis of fluorinated acid polymers has been described in, for example, A. Feiring et al., J. Fluorine Chemistry 2000, 105, 129-135; A. Feiring et al., Macromolecules 2000, 33, 9262-9271; D. D. Desmarteau, J. Fluorine Chem. 1995, 72, 203-208; A. J. Appleby et al., J. Electrochem. Soc. 1993, 140 (1), 109-111; and Desmarteau, U.S. Pat. No. 5,463,005.

in some embodiments, the fluorinated acid polymer also comprises a repeat unit derived from at least one highly-fluorinated ethylenically unsaturated compound. The perfluoroolefin comprises 2 to 20 carbon atoms. Representative perfluoroolefins include, but are not limited to, tetrafluoroethylene, hexafluoropropylene, perfluoro-(2,2-dimethyl-1,3-dioxole), perfluoro-(2-methylene-4-methyl-1,3-dioxolane), CF2=CFO(CF2)tCF=CF2, where t is 1 or 2, and Rf″OCF=CF2 wherein R_{f}″ is a saturated perfluoroalkyl group of from 1 to about 10n carbon atoms.

Preferably, the comonomer is tetrafluoroethylene.

in some embodiments, fluorinated acid polymer includes a highly-fluorinated carbon backbone and side chains represented by the formula:

—(O-CF2CFR_{f}³)ₐ—O—CF₂CFR_{f}⁴SO₃E⁵

wherein
R_{f}³ and R_{f}⁴ are independently selected from F, Cl or a highly-fluorinated alkyl group having 1 to 10 carbon atoms,
a=0, 1 or 2, and
E⁵ is selected from hydrogen or a cation such as Li, Na, or K.

in some embodiments, the fluorinated acid polymer can be the polymers disclosed in U.S. Pat. No. 3,282,875 and in U.S. Pat. Nos. 4,358,545 and 4,940,525,

in some embodiments, the fluorinated acid polymer comprises a perfluorocarbon backbone and the side chain represented by the formula

—O—CF₂CF(CF₃)—O—CF₂CF₂SO₃E⁵

where
E⁵ is selected from hydrogen or a cation such as Li, Na, or K.

Fluorinated acid polymers of this type are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro (3,6-dioxa-4-methyl-7-octenesulfonyl fluoride) (PDMOF), followed by conversion to sulfonate groups by hydrolysis of the sulfonyl fluoride groups and ion exchanged as necessary to convert them to the desired ionic form.

An example of a polymer of the type disclosed in U.S. Pat. Nos. 4,358,545 and 4,940,525 has the side chain —O—CF₂CF₂SO₃E⁵, wherein ES is as defined above. This polymer can be made by copolymerization of tetrafluoroethylene (TFE) and the perfluorinated vinyl ether CF₂═CF—O—CF₂CF₂SO₂F, perfluoro (3-oxa-4-pentenesulfonyl fluoride) (POPF), followed by hydrolysis and further ion exchange as necessary.

One type of fluorinated acid polymer is available commercially as Nafion® dispersions, from The Chemours Company (Wilmington, DE). Suitably Nafion® dispersions for use in the invention include Nafion® 212.

### Composite Catalytic Material

in an example, there is provided a composite catalytic material comprising
a catalyst comprising a metal or metal oxide of group 4 to 11, and
an electrically conductive material comprising an electrically conductive polymer,
said catalyst and electrically conductive material being supported by an (N-doped) carbon nanofoam material.

By “comprising a metal” is meant that the catalyst comprises the metal, but not necessarily in metallic form. For instance, the catalytic metal may be present as a sulphide, phosphide, or carbide. Preferably, the metal is in metallic form.

The (N-doped) carbon nanofoam material is preferably an N-doped carbon nanofoam, particularly an N-doped carbon nanofoam such as the superstructure of coalesced N-doped carbon nanofoam particles as described above.

The (N-doped) carbon nanofoam material provides a scaffold for the catalyst and electrically conductive material, acting as a structural backbone which supports the catalyst and electrically conductive material.

The catalyst and electrically conductive material are supported by an (N-doped) carbon nanofoam material. This structure can be achieved by depositing the electrically conductive material and catalyst onto the (N-doped) carbon nanofoam material, coating the (N-doped) carbon nanofoam material with the electrically conductive material and catalyst.

Preferably, the (N-doped) carbon nanofoam material is enveloped in the electrically conductive material. In other words, the (N-doped) carbon nanofoam material is embedded in and surrounded by the electrically conductive material. This structure allows the electrically conductive material to provide a conductive connection to the catalytic particles, facilitating in the transfer of electrons either to or from the catalyst. Typically, the catalytic particles are co-deposited with the electrically conductive material, such that the electrically conductive material provides a conductive web between the catalytic particles.

The catalyst and electrically conductive material can be deposited on the (N-doped) carbon nanofoam material in a number of ways, either separately or in the same step. The catalyst may be deposited either before or after the electrically conductive material.

The catalyst is typically deposited via the polyol method. This methodology is well known in the art, and comprises suspending the metal precursor in a polyol such as ethylene glycol and heating the suspension.

The metal may be in the form of any of the OER, ORR, HER or HRR catalysts specified herein, and is selected to tune the catalyst to the particular reactivity that is required.

Preferred catalytic metals are selected from TI, V, Mn, Fe, Ru, Co, Rh, ir, Ni, Pd, Pt, or mixtures thereof, more preferably selected from Co, Fe, Ni, or mixtures thereof.

For example, the catalytic material may be metallic Co, Fe, Ni; alloys of Co, Fe, Ni; oxides of Co, Fe, Ni; or mixtures thereof, whereln preferably, when present, Fe is in a 3+oxidation state.

Preferably, the catalytic material facilitates a four-electron redox reaction (i.e. a reaction in which dioxygen is reduced to form water by reaction with protons and electrons without formation of hydrogen peroxide, or vice versa), and is selected from the preferred four-electron catalysts mentioned above. As such, the fuel cells of the disclosure have lower levels of hydrogen peroxide formation during use.

Preferred catalysts are selected from Co, CoP@a-CoOx, CoP, MoS₂, irOₓ, Pt, WC, Ni, NiFe, V₂O₅, TI and Nb.

Particularly preferred catalysts are selected from Co, CoP@a-CoOx, CoP, Ni, NiFe.

For OER and ORR catalysts in water-based fuel cells, cobalt is particularly preferred.

The catalytic metal is typically supported on the (N-doped) carbon nanofoam material as a nanoparticle, preferably with a small crystallite size.

Nanoparticles have a much higher surface to volume ratio, and therefore are the catalytic metal is more active when provided in this form. Additionally, small crystallite sizes result in higher internal stresses within the crystal, which leads to a more active surface.

For instance, for cobalt the crystallite size of the catalytic metal is preferably below 0.7 nm, more preferably below 0.6 nm.

Other metal atoms can still retain high catalytic activity with a larger crystallite size, as the metal atoms themselves are larger.

Preferably, when the composite catalytic material is being used as an OER catalyst in a water based fuel cell, the cobalt comprises cobalt phosphide, particularly Cop@a-CoOx (cobalt phosphide nanoparticles embedded in amorphous cobalt oxide nanoplates with heterojunction-like structure).

For ORR catalysts in a water-based fuel cell, cobalt metal or cobalt salts can be used, particularly cobalt salts having a crystallite size below 0.7 nm, preferably below 0.6 nm.

Suitable cobalt salts include those described above, and particularly cobalt nitrate or cobalt acetate,

The catalytic composite material typically contains from 1 to 20 wt % catalytic metal (i.e. total metal from groups 4 to 11), preferably from 5 to 15 wt % catalytic metal.

The amount of catalytic metal may be calculated using the following formula:

$$\frac{{W}_{m} \times \frac{n \times {A}_{m}}{M}}{{w}_{p} + {W}_{m} \times \frac{n \times {A}_{m}}{M}} \times 100$$

Where
Wₘ is the mass of the catalytic metal compound that is added grams (e.g. cobalt acetate)
Wₚ is the mass of the conductive polymer:carbon composite that is added in grams
Aₘ is the atomic mass of the catalytic metal
M is the molar mass of the catalytic metal compound
n is the number of metal atoms in the molecular formula of the catalytic metal compound

in this formula, the component:

$$\frac{n \times {A}_{m}}{M}$$

Represents the fraction of the catalytic metal compound that is actually the catalytic metal.

in an electronic device such as a fuel cell, the composite catalytic material may be deposited on an electrode, such that the electrically conductive material provides the electrical connection between the catalyst and the electrode.

The electrically conductive material comprises an electrically conductive polymer. The electrically conductive polymer may be any of the electrically conductive polymers as described herein.

in some embodiments, the electrically conductive polymer is a poly-N-aryl polymer.

in some embodiments, the electrically conductive polymer is selected from the group consisting of a polypyrrole, a polyaniline, and combinations thereof.

in some embodiments, the electrically conductive polymer is selected from the group consisting of unsubstituted polypyrrole, unsubstituted polyaniline, and combinations thereof.

The electrically conductive polymer is preferably selected from polypyrrole, polyaniline, and mixtures thereof.

Preferably, the electrically conductive polymer is a mixture of polypyrrole and polyaniline.

Preferably, the electrically conductive polymer is formed in the presence of a non-polymeric aromatic sulfonic acid, for instance toluene sulphonic acid.

The electrically conductive polymer may be formed in the presence of the (N-doped) carbon nanofoam material. This methodology typically results in (N-doped) carbon nanofoam material being enveloped by the electrically conductive polymer.

The catalyst may be deposited either directly on the surface of the (N-doped) carbon nanofoam material, or on the surface of the (N-doped) carbon nanofoam material coated with the electrically conductive material, or co-deposited on the surface of the (N-doped) carbon nanofoam material together with the electrically conductive material.

The electrically conductive polymer may be partially carbonised.

By “carbonised” is meant converted into carbon material via heating.

By “partially carbonised” is meant that the electrically conductive polymer is present in both carbonised and non-carbonised form. A partially carbonised system may be formed by heating the system at a temperature sufficient to induce carbonisation (i.e. the conversion of the organic material into networked carbon or graphite-like deposits) for a time which is insufficient to cause complete carbonisation.

Without wishing to be bound by theory, it is considered that the four-electron pathway for oxygen reduction is promoted when the reaction kinetics are fast, for example when the composite catalytic material has good electrical properties. It is therefore preferable to provide an electrically conductive polymer with good electrical properties.

The electrically conductive polymer of the disclosure preferably has a conductivity of from 1 to 1000, preferably from 1 to 500, more preferably from 1 to 250 S/cm⁻²

Preferably, the composite catalytic material comprises
a catalyst comprising a metal or metal oxide of group 4 to 11,
an electrically conductive material comprising a partially carbonised electrically conductive polymer,
said catalyst and electrically conductive material being supported by an (N-doped) carbon nanofoam material, and
said (N-doped) carbon nanofoam material being enveloped in the electrically conductive material.

As carbonisation typically progresses from the exposed surface, the partially carbonised electrically conductive polymer typically comprises a core comprising electrically conductive polymer, and a shell comprising conductive carbonised material.

Thus, preferably, the composite catalytic material comprises
a catalyst comprising a metal or metal oxide of group 4 to 11,
an electrically conductive material comprising a core comprising electrically conductive polymer and a shell comprising conductive carbonised material,
said catalyst and electrically conductive material being supported by an (N-doped) carbon nanofoam material, and
said (N-doped) carbon nanofoam material being enveloped in the electrically conductive material.

The carbonisation of the electrically conductive polymer causes partial fusing of the polymer with the (N-doped) carbon nanofoam material to increase the conductivity of the catalytic material. However, complete carbonisation can lead to a loss of electrical conductivity, which is thought to be due to cracking that occurs during graphitic crystallisation of the material, leading to insulative gaps between the graphitic plates. Residual conductive polymer even at low levels bridges these gaps to maintain high conductivity of the material as a whole.

Partial carbonisation of the polymer leads to fusion of the polymer to the (N-doped) carbon nanofoam material, improving the electrical conductivity between the bulk material and the catalytic centres.

Preferably, the composite catalytic material comprises partially carbonised electrically conductive polymer selected from polypyrrole, poiyaniline, or mixtures thereof.

The formation of the partially carbonised electrically conductive polymer from N-containing heteroaromatics such as pyrrole or aniline provides N-doped graphite platelets which contain reactive nitrogen sites similar to those in the (N-doped) carbon nanofoam material described above. These are advantageous as they facilitate the catalytic reactions that occur in fuel cells.

The composite catalytic material may be formed by a method comprising:
forming an electrically conducting polymer by oxidative polymerisation in the presence of an (N-doped) carbon nanofoam material to form a polymer:(N-doped) carbon nanofoam composite;
depositing a catalytic metal on the (N-doped) carbon nanofoam material; and
optionally partially carbonizing the electrically conductive polymer.

The disclosure also relates to composite catalytic materials formed by partially carbonizing a material comprising:
a catalyst comprising a metal or metal oxide of group 4 to 11, and
an electrically conductive material comprising an electrically conductive polymer,
   said catalyst and electrically conductive material being supported by an (N-doped) carbon nanofoam material.

The step of depositing the catalytic metal on the N-doped carbon composite typically comprises co-dispersing the materials and removing the solvent. Sonication or other dispersing methodologies may be used to aid in the dispersing and intermixing of the components,

After removal of the solvent, the resultant material may optionally be partially carbonised by heating in an inert atmosphere, for instance under argon, to a temperature sufficient to degrade the electrically conductive polymer.

Typically, the material is heated at a temperature from 500° C. to 1100° C., preferably from 700° C. to 900° C., and most preferably from 750° C. to 850° C., for a time of 30 min to 4 hours, preferably from 1 to 3 hours.

The formation of electrically conducting polymer by oxidative polymerisation is well known in the art and also described herein. Typically, this polymerisation is carried out prior to combination with the catalytic metal, so as to ensure the catalyst is not poisoned by the polymerisation process and additionally polymerisation is not impacted by the catalytic metal.

The electrically conductive polymer is typically formed in the presence of a non-polymeric acid, for instance a non-polymeric aromatic sulfonic acid or non-polymeric aromatic carboxylic acid.

in an example, the electrically conductive polymer is formed in the presence of benzene sulfonic acid or toluene sulfonic acid, preferably toluene sulfonic acid.

in a preferred embodiment, the first step comprises
forming a polypyrrole in the presence of an (N-doped) carbon nanofoam material and polyaniline to form a polypyrrole:polyaniline:(N-doped) carbon nanofoam material composite.

Polypyrrole based systems have been found to display excellent lifetime as a fuel cell catalyst, while polyaniline provides structural integrity to the overall catalyst composite.

in all the embodiments of composite catalytic material described herein, the (N-doped) carbon nanofoam material is preferably an N-doped carbon nanofoam material.

Preferred composite catalytic materials are selected from the group consisting of (all of which may be partially carbonised) (the suitable use of the material is stated in parenthesis, for information):
CoP@a-CoOx:Ppy-TsOH:C_{nf}-Nₓ (bifunctional with a propensity towards ORR);
ORR); Cop@a-CoOx:PANi:Ppy-TsOH:C_{nf}-Nₓ (bifunctional with a propensity towards
Co:Ppy-TsOH:C_{nf} (bifunctional);
Co:PANi:Ppy-TsOH:C_{nf} (bifunctional);
Co:Ppy-TsOH:C_{nf}-Nₓ (bifunctional with a propensity towards ORR);
Co:PANi:Ppy-TsOH:C_{nf}-Nₓ (bifunctional with a propensity towards ORR);
Co:Ppy-TsOH:C_{nf} (bifunctional with a propensity towards ORR);
Co:PANi:Ppy-TsOH:C_{nf} (bifunctional with a propensity towards ORR);
CoP:Ppy-TsOH:C_{nf} (bifunctional with a propensity towards ORR);
CoP:PANi:Ppy-TsOH:Car (bifunctional with a propensity towards ORR);
MoS₂:Ppy-TsOH:C_{nf}-Nₓ (ORR);
MoS₂:PANi:Ppy-TsOH:C_{nf}-Nₓ (ORR);
irOₓ:Ppy-TsOH:C_{nf}-Nₓ (ORR);
irOₓ:PANi:Ppy-TsOH:C_{nf}-Nₓ (ORR);
Pt:Ppy-TsOH:C_{nf}-Nₓ (bifunctional);
Pt:PANi:Ppy-TsOH:C_{nf}-Nₓ (bifunctional);
Pt-TI-W:Ppy-TsOH:C_{nf}-Nₓ (blfunctional with a propensity towards OER);
Pt-TI-W:PANi:Ppy-TsOH:C_{nf}-Nₓ (bifunctional with a propensity towards OER);
WC:Ppy-TsOH:Cat-Nₓ (bifunctional with a propensity towards OER);
WC:PANi:Ppy-TsOH:C_{nf}-Nₓ (bifunctional with a propensity towards OER);
Ni:Ppy-TsOH:C_{nf}-Nₓ;
Ni:PANi:Ppy-TsOH:C_{nf}-Nₓ;
NiFe:Ppy-TsOH:C_{nf}-Nₓ;
NiFe:PANi:Ppy-TsOH:C_{nf}-Nₓ;
V₂O₅:Ppy-TsOH:C_{nf}-Nₓ (bifunctional with a propensity towards OER);
V₂O₅:PANi:Ppy-TsOH:C_{nf}-Nₓ (bifunctional with a propensity towards OER);
TI:PPYTSOF:C_{nf}-Nₓ;
TI:PANi:PPyTSOF:C_{nf}-Nₓ;
Nb:Ppy-TsOH:C_{nf}-Nₓ (bifunctional with a propensity towards OER); and
Nb:PANi:Ppy-TsOH:C_{nf}-Nₓ (bifunctional with a propensity towards OER).

Preferred composite catalytic materials are selected from the group consisting of (all of which may be partially carbonised);
Cop@a-CoOx:Ppy-TsOH:C_{nf}-Nₓ;
Cop@a-CoOx:PANi:Ppy-TsOH:C_{nf}-Nₓ;
Co:Ppy-TsOH:C_{nf}-Nₓ;
Co:PANi:Ppy-TsOH:C_{nf}-Nₓ;
CoP:Ppy-TsOH:C_{nf};
COP:PANi:Ppy-TsOH:C_{nf};
MoS₂:Ppy-TsOH:C_{nf}-Nₓ;
MoS₂:PANi:Ppy-TsOH:C_{nf}-Nₓ;
Pt:Ppy-TsOH:C_{nf}-Nₓ;
Pt:PANi:Ppy-TsOH:C_{nf}-Nₓ;
Pt-TI-W:Ppy-TsOH:CH-Nₓ;
Pt-TI-W:PANi:Ppy-TsOH:C_{nf}-Nₓ;
WC:Ppy-TsOH:C_{nf}-Nₓ;
WC:PANi:Ppy-TsOH:C_{nf}-Nₓ;
NiFe:Ppy-TsOH:C_{nf}-Nₓ;
NiFe:PANi:Ppy-TsOH:C_{nf}-Nₓ;
V₂O₅:Ppy-TsOH:C_{nf}-Nₓ;
V₂O₅:PANi:Ppy-TsOH:C_{nf}-Nₓ;
Nb:Ppy-TsOH:Cn-Nₓ; and
Nb:PANi:Ppy-TsOH:C_{nf}-Nₓ.

Particularly preferred composite catalytic materials are selected from the group consisting of (all of which may be partially carbonised):
CoP@a-CoOx:PANi:Ppy-TsOH:C_{nf}-Nₓ;
Co:Ppy-TsOH:C_{nf}-Nₓ;
Co:Ppy-TsOH:C_{nf};
CoP:Ppy-TsOH:C_{nf};
MoS₂:Ppy-TsOH:C_{nf}-Nₓ;
irOₓ:Ppy-TsOH:C_{nf}-Nₓ;
Pt:Ppy-TsOH:C_{nf}-Nₓ;
Pt-TI-W:Ppy-TsOH:C_{nf}-Nₓ;
WC:Ppy-TsOH:C_{nf}-Nₓ;
Ni:Ppy-TsOH:C_{nf}-Nₓ;
NiFe:Ppy-TsOH:C_{nf}-Nₓ;
V₂O₅:Ppy-TsOH:C_{nf}-Nₓ; and
Nb:Ppy-TsOH:C_{nf}-Nₓ.

Preferred composite catalytic materials for ORR catalysts are selected from the group consisting of (all of which may be partially carbonised):
CoP@a-CoOx:Ppy-TsOH:C_{nf}-Nₓ;
CoP@a-CoOx:PANi:Ppy-TsOH:C_{nf}-Nₓ;
Co:Ppy-TsOH:C_{nf}-Nₓ;
Co:PANi:Ppy-TsOH:C_{nf}-Nₓ;
Co:Ppy-TsOH:C_{nf};
Co:PANi:Ppy-TsOH:C_{nf};
CoP:Ppy-TsOH:C_{nf};
CoP:PANi:Ppy-TsOH:C_{nf};
MoS₂:Ppy-TsOH:C_{nf}-Nₓ;
MoS₂:PANi:Ppy-TsOH:C_{nf}-Nₓ;
irOₓ:Ppy-TsOH:C_{nf}-Nₓ; and
irOₓ:PANi:Ppy-TsOH:C_{nf}-Nₓ.

Preferred composite catalytic materials for OER catalysts are selected from the group consisting of (all of which may be partially carbonised):
Pt:Ppy-TsOH:C_{nf}-Nₓ;
Pt:PANi:Ppy-TsOH:C_{nf}-Nₓ;
Pt-TI-W:Ppy-TsOH:C_{nf}-Nₓ;
Pt-TI-W:PANi:Ppy-TsOH:C_{nf}-Nₓ;
WC:Ppy-TsOH:C_{nf} Nₓ;
WC:PANi:Ppy-TsOH:C_{nf}-Nₓ;
V₂O₅:Ppy-TsOH:C_{nf}-Nₓ;
V₂O₅:PANi:Ppy-TsOH:C_{nf}-Nₓ;
Nb:Ppy-TsOH:C_{nf}-Nₓ; and
Nb:PANi:Ppy-TsOH:C_{nf}-Nₓ.

As used above:
PANi denotes polyaniline;
Ppy denotes to polypyrrole;
TsOH denotes toluene sulphonic acid;
C_{nf}-Nₓ denotes (N-doped) carbon nanofoam material; and
C_{nf} denotes carbon nanofoam material.

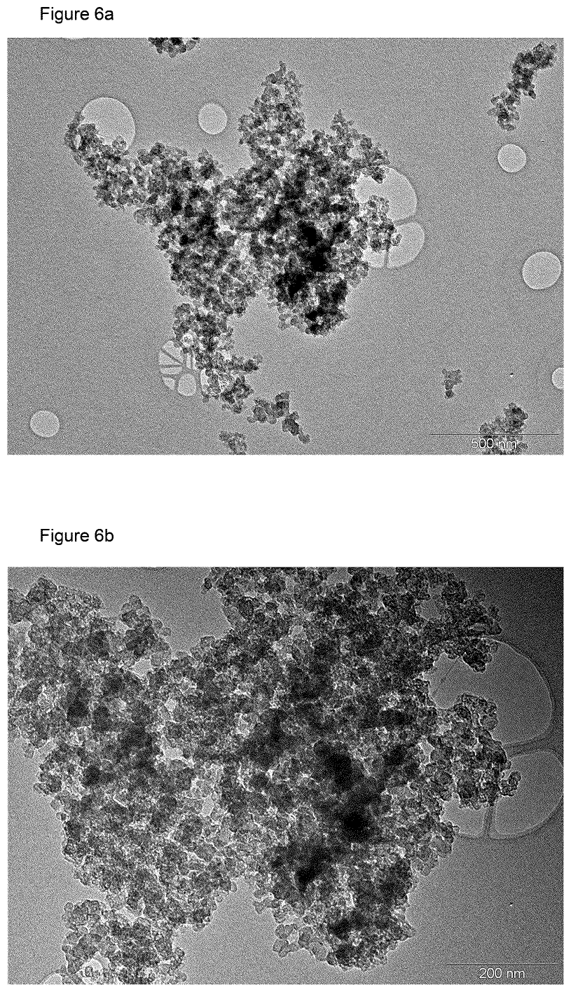

FiGS. 6a and 6b show TEM images of a Cop@a-CoOx:PANi:Ppy-TsOH:C_{nf}-Nₓ ORR composite material.

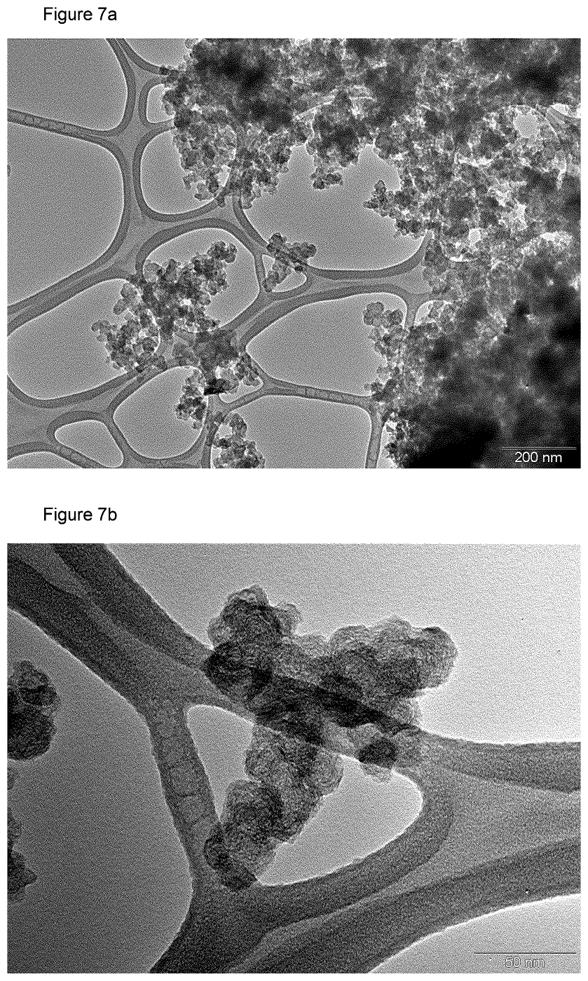

FiGS. 7a and 7b show TEM images of a PANi:polypyrrole-TsOH:(N-doped) carbon nanofoam material:cobalt OER composite material.

The composite catalytic material may be applied to a suitable electrode, such as the porous first electrode described above.

Suitable methods of applying the composite catalytic material include any of spin coating, dip coating, drop casting, spray coating, or brush coating a dispersion of the composite onto the electrode surface.

The electrode itself is usually high surface area and as such has an uneven surface texture. In view of this, spin coating is preferred as it typically provides a thin and even coating over the electrode surface.

Optionally, the composite catalytic material may be applied to the electrode surface prior to carbonisation, and the partial carbonisation step is carried out in situ on the electrode.

if necessary, the composite catalytic material may be applied as a dispersion with a binder to improve adhesion to the surface. Suitable binders include fluorinated acid polymers as described herein. If present, the binder is usually used at below 5 wt %, preferably below 3 wt %.

The composite catalytic material preferably comprises the superstructure of coalesced (N-doped) carbon nanofoam particles. In such embodiments, the overall structure of the composite catalytic material resembles a superstructure of coalesced particles, said particles preferably having a diameter of from 0.005 to 25 μm, e.g. from 0.01 to 15 μm, or from 0.01 to 5 μm, or from 0.01 to 2 μm in diameter.

Smaller particles are preferred, as they provide a much higher surface area. In preferred embodiments, the composite catalytic material has a superstructure of coalesced particles of from 0.01 to 1 μm in diameter, preferably from 0.01 to 0.5 μm in diameter, preferably from 0.01 to 0.2 μm in diameter.

The diameters of the superstructure of particles may be measured by SEM. Typically, in such a process the largest dimension of the particle is measured.

in an example, the composite catalytic material has a superstructure of coalesced particles, said superstructure having a tortuous path of open pores at least 3 times the average diameter of the individual particles, preferably at least 5 times the average diameter of the individual particles, for instance from 5 to 100 times, preferably from 5 to 50 times the average diameter of the individual particles.

The composite catalytic material typically has a surface area of from 50 to 2500 m²/g, preferably from 50 to 2000 m²/g, preferably from 50 to 1800 m²/g, preferably from 50 to 1500 m²/g, preferably from 50 to 1200 m²/g, preferably from 50 to 800 m²/g.

The surface area may be measured by BET isotherm, for instance at 77 K using nitrogen.

The composite catalytic materials are typically characterised by a minimum overvoltage of from 10 mV, preferably from 10 to 100 mV, more preferably a minimum overvoltage of from 15 to 90 mV.

The composite catalytic material is typically characterised by a conductivity (S/cm⁻²) of from 1 to 1000, preferably from 1 to 500, more preferably from 1 to 250 S/cm⁻².

### Protocols for Measurements

### Calculation of Pore Size

To calculate pore diameters of micropore levels and smaller, the inventors have used the protocol set out in Kawazoe et al., J. Chem. Eng. Japan, 16 (6), 1983, 470-475,

The above protocol describes a method for the calculation of effective pore size distribution from adsorption isotherms. Calculation of the pore size distribution was done from N₂ isotherms at 77 K.

For measurement of the N₂ isotherms at liquid N₂ temperature a sample (˜0.3 g) was put into a sample holder and degassed at 200° C. and 10⁻⁵ Torr (1.33×10⁻³ Pa) pressure for at least 48 hours. A Cahn electrobalance provided highly accurate mass measurement. For the measurement of pressure ULVAC ionization vacuum gauges and MKS Baratron sensors were used (pressure ranges 1.33×10⁻⁶-6.65×10⁻¹ Pa; 1.33×10⁻¹-10⁵ Pa).

To calculate pore volumes greater than 1.5 nm, the inventors have used the following protocol:Dollimore, D. and G. R. Heal et al., J. Appl. Chem., 14, 1964, 109-114.

The above protocol describes a method for calculating the pore size distribution from adsorption isotherms on porous solids.

Herein, the total amount of nitrogen taken up at a pressure of 1 atmosphere and a temperature of 77K gave the total pore volume. With the model of cylindrical pores the total pore volume was calculated using:

$$1 / 4 * pi * d * d * l ,$$

where
d is the mean pore diameter and
i is the total length of the pores.

if the BET surface area measured the total surface area of the pores, the BET surface area S(BET)=pi*d*i. From the two equations i was eliminated and the average diameter d was calculated.

The Barrett-Joiner-Halenda (BJH) procedure assumes capillary condensation of the liquid nitrogen within the pores and calculates from the relative pressures and the amount of nitrogen taken up at a given relative pressure of the sorption isotherm taking into account the adsorbed layer of nitrogen and the capillary condensed nitrogen the pore size distribution. The adsorption and the desorption branch lead to different pore size distributions. Therefore, the desorption branch was usually employed.

### Surface Area

Samples were treated at elevated temperatures (120° C.) and reduced pressures for at least 8 hours before nitrogen sorption to remove any bound gases and adsorbed water from the materials.

The Na sorption analysis may be performed using a Belsorp Mini (Bel Japan, inc.) apparatus at 77K, using liquid gas for each respective test, and surface areas calculated using the Brunauer-Emmett-Teller (BET) theory using sorption data.

### Calculation of Density for Carbon Nanofoams

The following methods were used:

Displacement density method:using water as the displacement medium, density is calculated at 22° C., 1atm of pressure and using the equation D=m/v (mass divided by volume).

TAP density method, as described by:
The international Pharmacopoeia, s.3.6. Bulk Density and Tapped Density of Powders, QAS11_450 FiNAL (modified March 2012). The tapped density is an increased bulk density attained after mechanically tapping a container containing the powder sample.
Here, the tapped density is obtained by mechanically tapping a graduated cylinder containing the sample until little further volume change is observed. The tapping can be performed using different methods. The tapped density is calculated as mass divided by the final volume of the powder.

A mean average was subsequently taken of the two measurement methodologies.

### Conductivity of the Pulverized Material Samples

Spin coating was used to prepare the material samples. The material samples were prepared in the same manner as the preparation steps for making electrodes. Namely, a silver foil in a solution containing the material samples and a 5% addition of binder.

if the resistance of the material samples was of a magnitude of kiloohms or more, a two-point probe was used.

The spin coated film is mounted in a metallic sample holder and a vacuum is created inside to get rid of moisture.

2-Point and 4-Point probe tests may be used.

The conductivity of the samples that was measured was on average 0.4 S/cm to 100 S/cm depending on layer thickness and conductivity of the carbon support utilized. Measurement of conductive polymer concentration within sample materials

One method for measuring the conductive polymer concentration within sample materials includes solvating sample materials in an appropriate solvent. The solubility of polypyrrole (PPy) is highly restrained, practically insolvable, owing to the extensive cross-linking of the polymer backbone. Neutral PPy is generally considered insoluble, but it can swell when exposed to some solvents. Once swelled, PPy can be doped, either in acid or basic media, with some charge-compensating anions (e.g. OH—). The doped PPy can be dissolved in a few solvents after this doping, such as chloroform, dimethyl sulfoxide (DMSO), m-cresol, N-Methyl-2-pyrrolidone (NMP), and tetrahydrofuran (THF).

An alternative method includes using Raman Spectroscopy, X-ray diffraction Spectroscopy, and iR Spectroscopy to determine the presence of polymer chains within the sample materials. The inventors have utilised this method of measurement via the UGhent materials science laboratory.

Preferences, options and embodiments for a given aspect, feature or parameter of the invention should, unless the context indicates otherwise, be regarded as having been disclosed in combination with any and all preferences, options and embodiments for all other aspects, features and parameters of the invention. Embodiments and features of the present invention are also outlined in the following items.

A1. An (N-doped) carbon nanofoam material comprising a superstructure of coalesced N-doped carbon nanofoam particles, said particles having a diameter of from 0.005 μm to 25 μm.

A2. (N-doped) carbon nanofoam material according to item A1, wherein the carbon nanofoam particles have a diameter of from 0.01 to 15 μm.

A3. (N-doped) carbon nanofoam material according to item A1 or A2, wherein the carbon nanofoam particles have a diameter of from 0.01 to 5 μm.

A4. (N-doped) carbon nanofoam material according to any one of items A1-A3, wherein the carbon nanofoam particles have a diameter of from 0.01 to 2 μm.

A5. (N-doped) carbon nanofoam material according to any one of items A1-A4, wherein the carbon nanofoam particles are mesoporous.

A6. (N-doped) carbon nanofoam material according to any one of items A1-A5, wherein the material has a superstructure of coalesced N-doped carbon nanofoam particles, said superstructure having a tortuous path of open pores at least 3 times the average diameter of the nanofoam particles.

A7. (N-doped) carbon nanofoam material according to any one of items A1-A6, wherein the open pores of the superstructure have a mean pore size of 10 to 100 μm.

A8. (N-doped) carbon nanofoam material according to item A7, wherein the open pores of the superstructure have a mean pore size of 0.2 to 2 μm.

A9. (N-doped) carbon nanofoam material according to any one of items A1-A8, wherein the material has a density of below 300 mg/cm³.

A10. (N-doped) carbon nanofoam material according to item A9, wherein the material has a density of 50 to 200 mg/cm³.

A11. (N-doped) carbon nanofoam material according to item A10, wherein the material has a density of 50 to 150 mg/cm³.

A12. An (N-doped) carbon nanofoam material according to any one of items A1-A11, wherein the N-doped carbon nanofoam has an N content of from 0.1 to 8 wt %.

A13. An (N-doped) carbon nanofoam material according to any one of items A1-A11, wherein the N-doped carbon nanofoam has an N content of from 1 to 5 wt %.

A14. An (N-doped) carbon nanofoam material according to any one of items A1-A13, wherein the N-doped carbon nanofoam has a surface area of from 200 to 3500 m²/g.

A15. An (N-doped) carbon nanofoam material according to any one of items A1-A13, wherein the N-doped carbon nanofoam has a surface area of from 1000 to 2000 m²/g.

A16. An (N-doped) carbon nanofoam material according to any one of items A1-A13, wherein the (N-doped) carbon nanofoam material has a surface area of from 1200 to 1800 m²/g.

A17. An (N-doped) carbon nanofoam material according to any one of items A1-A16, wherein the carbon nanofoam is an N-doped carbon nanofoam material.

B1. A method of forming an (N-doped) carbon nanofoam material comprising:
i. forming a mixture of sugar, water and hydrocarbon mediator;
ii. heating said mixture to form a carbon nanofoam; and
iii. optionally heating the carbon nanofoam in an acidic nitrogen source (e.g. nitric acid) to form an N-doped carbon nanofoam.

B2. A method according to item B1, wherein the sugar is one or more monosaccharide, disaccharide and/or trisaccharide.

B3. A method according to item B2, wherein the sugar is one or more of sucrose, glucose or fructose.

B4. A method according to item B3, wherein the sugar is sucrose.

B5. A method according to any one of items B1-B4, wherein the solution of sugar and water is a concentration of at least 3 mol/dm³.

B6. A method according to any one of items B1-B5, wherein the solution of sugar and water is a concentration of at least 4 mol/dm³.

B7. A method according to any one of items B1-B6, wherein the solution of sugar and water is a concentration of at least 5 mol/dm³.

B8. A method according to any one of items B1-B7, wherein the solution is fully dissolved in the water to form the mixture of sugar and water.

B9. A method according to item B8, wherein the sugar is dissolved in the water by heating and stirring vigorously.

B10. A method according to item B9, wherein the sugar is dissolved in the water by heating the solution from 50° C. to 85° C.

B11. A method according to item B9, wherein the sugar is dissolved in the water by heating the solution from 60° C. to 80° C.

B12. A method according to any one of items B5-B11, wherein the solution of sugar and water is cooled before the hydrocarbon mediator is added.

B13. A method according to item B12, wherein the solution of sugar and water is cooled to below 50° C. before the hydrocarbon mediator is added.

B14. A method according to any one of items B1-B13, wherein the hydrocarbon mediator is an aromatic hydrocarbon.

B15. A method according to item B14, wherein the aromatic hydrocarbon is pyrene.

B16. A method according to item B14, wherein the aromatic hydrocarbon is chrysene.

B17. A method according to item B14, wherein the aromatic hydrocarbon is benz[a]anthracene.

B18. A method according to item B14, wherein the aromatic hydrocarbon is fluoranthene.

B19. A method according to item B14, wherein the aromatic hydrocarbon is anthracene.

B20. A method according to item B14, wherein the aromatic hydrocarbon is naphthalene.

B21. A method according to item B14, wherein the aromatic hydrocarbon is benzene.

B22. A method according to item B14, wherein the aromatic hydrocarbon is hexane.

B23. A method according to any one of items B1-B13, wherein the hydrocarbon mediator is one or more of the aromatic hydrocarbons of items B15-B22.

824. A method according to item B1, wherein the hydrocarbon mediator is naphthalene and the sugar is sucrose.

B25. A method according to any one of items B1-B24, wherein the ratio of hydrocarbon mediator to sugar is from 1:25,000 to 1:75,000.

B26. A method according to any one of items B1-B25, wherein the ratio of hydrocarbon mediator to sugar is from 1:50,000 to 1:65,000.

B27. A method according to any one of items B1-B26, wherein step ii is carried out at a temperature and for a time sufficient to carbonize the sugar to form a particulate material.

B28. A method according to item B27, wherein step ii is carried out at a temperature from 100° C. to 600° C. for 30 minutes to 24 hours.

B29. A method according to item B28, wherein step ii is carried out at a temperature of 350° C. to 600° C. for 30 minutes to 3 hours.

B30. A method according to item B29, wherein step ii is carried out at a temperature of 100° C. to 300° C. for 4 hours to 12 hours.

B31. A method according to any one of items B1-B30, wherein step ii is carried out in an inert vessel.

B32. A method according to any one of items B1-B31, wherein step ii is carried out in a sealed reactor.

B33. A method according to any one of items B1-B32, wherein the nanofoam produced in step ii is comminuted.

B34. A method according to item B33, wherein the carbon nanofoam particles coalesce to form a superstructure.

B35. A method according to items B33 or B34, wherein the carbon nanofoam particles are mesoporous.

B36. A method according to any one of items B33-B35, wherein the carbon nanofoam particles formed in step ii are from 0.1 to 25 μm in diameter.

B37. A method according to any one of items B33-B36, wherein the carbon nanofoam particles formed in step ii are from 0.2 to 15 μm in diameter.

B38. A method according to any one of items B33-B37, wherein the carbon nanofoam particles formed in step ii are from 0.5 to 5 μm in diameter.

B39. A method according to any one of items B33-B38, wherein the carbon nanofoam particles formed in step ii are from 0.5 to 2 μm in diameter.

B40. A method according to any one of items B1-B39, wherein the carbon nanofoam in step ill is heated to at least at least 80° C. for at least 2 hours.

B41. A method according to any one of items B1-B40, wherein the carbon nanofoam in step ill is heated to at least at least 90° C. for at least 4 hours.

B42. A method according to any one of items B1-B41, wherein the carbon nanofoam in step iii is heated to between 95° C. to 115° C. for at least 4 hours.

B43. A method according to any one of items B1-B42, wherein step iii is carried out in a suitable acid resistant pressure vessel.

B44. A method according to any one of items B1-B43, wherein the acidic nitrogen source (e.g. nitric acid) used in step iii is at a concentration of from 3 mol/dm³ to 10 mol/dm³.

B45. A method according to any one of items B1-B44, wherein the acidic nitrogen source (e.g. nitric acid) used in step iii is at a concentration of from 4 mol/dm³ to 8 mol/dm³.

B46. A method according to any one of items B1-B44, wherein an the acidic nitrogen source is selected from nitric acid.

B47. A method according to any one of items B1-B46, wherein the (N-doped) carbon nanofoam has an N content of from 0.1 to 8 wt %.

B48. A method according to any one of items B1-B47, wherein the (N-doped) carbon nanofoam has an N content of from 1 to 5 wt %.

B49. A method according to any one of items B1-B48, wherein the (N-doped) carbon nanofoam has a surface area of from 1000 to 3500 m²/g.

B50. A method according to any one of items B1-B49, wherein the (N-doped) carbon nanofoam has a surface area of from 1000 to 2000 m²/g.

B51. An (N-doped) carbon nanofoam material obtainable by the method of item B1 to B50.

E1. A composite catalytic material comprising
a catalyst comprising a metal or metal oxide of group 4 to 11, and
an electrically conductive material comprising an electrically conductive polymer,
said catalyst and electrically conductive material being supported by an (N-doped) carbon nanofoam material.

E2. A composite catalytic material according to item E1, wherein the (N-doped) carbon nanofoam material is an (N-doped) carbon nanofoam as described in any one of items A1-A17.

E3. A composite catalytic material according to item E1, wherein the (N-doped) carbon nanofoam material is a composite material according to item B51.

E4. A composite catalytic material according to any one of items E1 to E3, wherein the metal is a noble metal.

E5. A composite catalytic material according to item E4, wherein the noble metal is selected from Pt, ir or Ru.

E6. A composite catalytic material according to item E5, wherein the noble metal is Pt.

E7. A composite catalytic material according to item E6, wherein the Pt is in the form of a Pt metal alloy, described in the form Pt-M (wherein M=3d transition metal).

E8. A composite catalytic material according to item E7, wherein M is one or more of Ni, Co, Fe, Cu, Pd, Rh, TI, V, Cr, Mo, W and Re.

E9. A composite catalytic material according to item E7, wherein the Pt alloy is PtNi₃.

E10. A composite catalytic material according to item E7, wherein the Pt alloy is PtₓCo (wherein x=2, 3, 5, 7 and 9).

E11. A composite catalytic material according to item E7, wherein the Pt alloy is Pt₃Cu.

E12. A composite catalytic material according to item E7, wherein the Pt alloy is PtCu.

E13. A composite catalytic material according to item E7, wherein the Pt alloy is PtCu₃.

E14. A composite catalytic material according to item E6, wherein the Pt is in the form of a ternary Pt-based systems, described in the form Pt-M-N, wherein M is one or more of Ni, Co, Fe, Cu, Pd, Rh, TI, V, Cr, Mo, W and Re; and N is Fe, Cu, Ni or Co.

E15. A composite catalytic material according to item E14, wherein the ternary Pt-based system is Pt₂CuNi.

E16. A composite catalytic material according to item E14, wherein the ternary Pt-based system is Pt₃CONi.

E17. A composite catalytic material according to item E14, wherein the ternary Pt-based system is Pt₃FeNi.

E18. A composite catalytic material according to item E14, wherein the ternary Pt-based system is Pt₃FeCo.

E19. A composite catalytic material according to any one of items E1-E3, wherein the transition metal is selected from TI, V, Mn, Fe, Ru, Co, Rh, ir, Ni, Pd, Pt, or mixtures thereof.

E20. A composite catalytic material according to item E19, wherein the composite catalytic material is Mn, Co, Ni or Fe oxide.

E21. A composite catalytic material according to item E19, wherein the composite catalytic material comprises a cobalt based catalyst.

E22. A composite catalytic material according to item E19, wherein the cobalt based catalyst is selected from metallic cobalt, cobalt oxide, cobalt phosphides, cobalt halides, cobalt nitrates, cobalt chalcogenides (sulphide and selenides), Co-included layered double hydroxides, Co—N—C, Co-based single atoms, Co-MOFs (metal organic frameworks), cobalt carboxylates, Co-Nx/C and their composites.

E23. A composite catalytic material according to item E21, wherein the cobalt based catalyst is CoS.

E24. A composite catalytic material according to item E21, wherein the cobalt based catalyst is CoS₂.

E25. A composite catalytic material according to item E21, wherein the cobalt based catalyst is metallic cobalt.

E26. A composite catalytic material according to item E21, wherein the cobalt based catalyst is Co₃S₄.

E27. A composite catalytic material according to item E21, wherein the cobalt based catalyst is Co₃O₄.

E28. A composite catalytic material according to item E21, wherein the cobalt based catalyst is CoO.

E29. A composite catalytic material according to item E21, wherein the cobalt based catalyst is CoP.

E30. A composite catalytic material according to item E21, wherein the cobalt based catalyst is Co₂P.

E31. A composite catalytic material according to item E21, wherein the cobalt based catalyst is Co₃P₂.

E32. A composite catalytic material according to item E21, wherein the cobalt based catalyst is formed from cobalt acetate.

E33. A composite catalytic material according to item E21, wherein the cobalt based catalyst is formed from cobalt oxalate.

E34. A composite catalytic material according to item E21, wherein the cobalt based catalyst is formed from cobalt nitrate.

E35. A composite catalytic material according to item E21, wherein the cobalt based catalyst is formed from cobalt chloride.

E36. A composite catalytic material according to E19, wherein the transition metal is selected from metallic Co, Fe, Ni; alloys of Co, Fe, Ni; oxides of Co, Fe, Ni; or mixtures thereof, wherein preferably, when present, Fe is in a 3+oxidation state.

E37. A composite catalytic material according to any one of items E1-E36, wherein the cobalt salts have a crystallite size below 0.7 nm.

E38. A composite catalytic material according to any one of items E1-E37, wherein the cobalt salts have a crystallite size below 0.6 nm.

E39. A composite catalytic material according to any one of items E1-E38, wherein the metal material is mixed, doped or combined with other materials.

E40. A composite catalytic material according to any one of items E39, wherein the other materials are carbon materials.

E41. A composite catalytic material according to item E29, wherein the Cop nanoparticles are embedded in amorphous cobalt oxides (CoOx) nanoplates with heterojunction-like structure (CoP@a-CoOx plate).

E42. A composite catalytic material according to any one of items E1-E41, wherein the catalysts are in the form of nanostructures, such as nanoparticles, nanospheres, nanowires, nanosheets, nano-rods, core-shell and hollow structures.

E43. A composite catalytic material according to item E42, wherein the catalysts are in the form of nanoparticles.

E44. A composite catalytic material according to item E43, wherein the nanostructure has an average size of from about 1 nm to about 200 nm.

E45. A composite catalytic material according to item E43, wherein the nanostructure has an average size of from about 20 nm to about 100 nm.

E46. A composite catalytic material according to item E43, wherein the nanostructure has an average size of from about 30 nm to about 80 nm.

E47. A composite catalytic material according to item E43, wherein the nanostructure has an average size of from about 30 nm to about 50 nm.

E48. A composite catalytic material according to any one of items E1-E47, wherein the electrically conductive polymer which has a conductivity greater than 10⁻⁷ S/cm.

E49. A composite catalytic material according to any one of items E1-E48, wherein the electrically conductive polymer is a homopolymer.

E50. A composite catalytic material according to any one of items E1-E48, wherein the electrically conductive polymer is a copolymer.

E51. A composite catalytic material according to item E50, wherein the copolymer is made from two or more conductive precursor monomers.

E52. A composite catalytic material according to item E50, wherein the copolymer is made from a combination of one or more conductive precursor monomers and one or more non-conductive precursor monomers.

E53. A composite catalytic material according to item E51 or E52, wherein the electrically conductive polymer is made from at least one conductive precursor monomer selected from thiophenes, seienophenes, tellurophenes, pyrroles, anilines, and polycyclic aromatics.

E54. A composite catalytic material according to item E51 or E52, wherein the electrically conductive polymer is a poly-N-aryl polymer.

E55. A composite catalytic material according to item E51 or E52, wherein the electrically conductive polymer is selected from an unsubstituted polypyrrole, an unsubstituted polyaniline, or mixtures thereof.

E56. A composite catalytic material according to item E51 or E52, wherein the electrically conductive polymer is made from a pyrrole monomer of formula (ii):

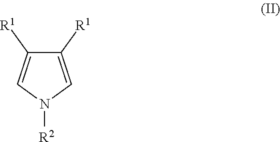

where in Formula.ii:
R¹ is independently selected so as to be the same or different at each occurrence and is selected from hydrogen, alkyl, alkenyl, alkoxy, alkanoyl, aryloxy, alkylaryl, arylalkyl, amino, alkylamino, dialkylamino, aryl, alkoxyalkyl, alkoxycarbonyl, acrylic acid, phosphoric acid, phosphonic acid, halogen, nitro, cyano, hydroxyl, epoxy, silane, siloxane, alcohol, benzyl, carboxylate, ether, ether carboxylate, and urethane; or
both R¹ groups together may form an alkylene or alkenylene chain completing a 3, 4, 5, 6, or 7-membered aromatic or alicyclic ring, which ring may optionally include one or more divalent nitrogen, or oxygen atoms; and
R² is independently selected so as to be the same or different at each occurrence and is selected from hydrogen, alkyl, alkenyl, aryl, alkanoyl, alkylaryl, arylalkyl, amino, epoxy, silane, siloxane, alcohol, benzyl, carboxylate, ether, ether carboxylate, and urethane.

E57. A composite catalytic material according to item E51 or E52, wherein the electrically conductive polymer is made from an aniline monomer of formula (iii):

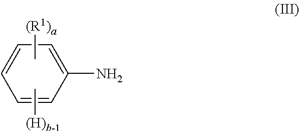

wherein:
a is 0 or an integer from 1 to 4;
b is an integer from 1 to 5, with the proviso that a+b=5; and
R¹ is independently selected so as to be the same or different at each occurrence and is selected from hydrogen, alkyl, alkenyl, alkoxy, alkanoyl, aryloxy, alkylaryl, arylalkyl, amino, alkylamino, dialkylamino, aryl, alkoxyalkyl, alkoxycarbonyl, acrylic acid, phosphoric acid, phosphonic acid, halogen, nitro, cyano, hydroxyl, epoxy, silane, siloxane, alcohol, benzyl, carboxylate, ether, ether carboxylate, and urethane; or
both R¹ groups together may form an alkylene or alkenylene chain completing a 3, 4, 5, 6, or 7-membered aromatic or alicyclic ring, which ring may optionally include one or more divalent nitrogen, or oxygen atoms.

E58. A composite catalytic material according to item E50 or E51, wherein the electrically conductive polymer is made from fused polycyclic heteroaromatic monomers.

E59. A composite catalytic material according to any of items E1-E52, wherein the electrically conductive polymer is selected from the group consisting of a polypyrrole, a polyaniline, and combinations thereof.

E60. A composite catalytic material according to any of items E1-E52, wherein electrically conductive polymer is selected from polypyrrole, polyaniline, and mixtures thereof.

E61. A composite catalytic material according to any one of items E1-E52, wherein the electrically conductive polymer is a mixture of polypyrrole and polyaniline,

E62. A composite catalytic material according to any one of items E1-E61, wherein the electrically conductive polymer is formed in the presence of a non-polymeric aromatic sulfonic acid.

E63. A composite catalytic material according to item E62, wherein the electrically conductive polymer is formed in the presence of toluene sulphonic acid.

E64. A composite catalytic material according to any one of items E1-E62, wherein the electrically conductive polymer is partially carbonised.

E65. A composite catalytic material according to E64, wherein the material comprises
a catalyst comprising a metal or metal oxide of group 4 to 11,
an electrically conductive material comprising a partially carbonised electrically conductive polymer,
said catalyst and electrically conductive material being supported by an (N-doped) carbon nanofoam material, and
   said (N-doped) carbon nanofoam material being enveloped in the electrically conductive material . . .

E66. A composite catalytic material according to any one of items E1-E65, wherein the electrically conductive material comprises a core comprising electrically conductive polymer, and a shell comprising conductive carbonised material.

E67. A composite catalytic material according to item E66, wherein the conductive carbonised material is formed by partially carbonising the electrically conductive polymer.

E68. A composite catalytic material according to E64, the composite catalytic material comprising partially carbonised electrically conductive polymer selected from polypyrrole, polyaniline, or mixtures thereof.

E69. A composite catalytic material according to any one of items E1-E68, wherein the material contains from 1 to 20 wt % catalytic metal.

E70. A composite catalytic material according to any one of items E1-E69, wherein the material contains from 5 to 15 wt % catalytic metal.

E71. A composite catalytic material according to any one of items E1-E70, wherein the (N-doped) carbon nanofoam material is enveloped by the electrically conductive material.

E72. A composite catalytic material according to any one of items E1-E71, wherein the material has a surface area of from 50 to 2500 m²/g.

E73. A composite catalytic material according to any one of items E1-E71, wherein the material has a surface area of from 50 to 1500 m²/g.

E74. A composite catalytic material according to any one of items E1-E71, wherein the material has a surface area of from 50 to 800 m²/g.

E75. A composite catalytic material according to any one of items E1-E74, wherein the composite catalytic material has a superstructure of coalesced particles, said particles having a diameter of from 0.005 to 25 μm.

E76. A composite catalytic material according to any one of items E1-E75, wherein the composite catalytic material has a superstructure of coalesced particles, said particles having a diameter of from 0.01 to 15 μm.

E77. A composite catalytic material according to any one of items E1-E76, wherein the composite catalytic material has a superstructure of coalesced particles, said particles having a diameter of from 0.01 to 2 μm.

E78. A composite catalytic material according to any one of items E75 to E77, wherein the superstructure has a tortuous path of open pores at least 3 times the average diameter of the individual particles.

E79. A composite catalytic material according to any one of items E75 to E77, wherein the superstructure has a tortuous path of open pores 5 to 50 times the average diameter of the individual particles.

E80. A composite catalytic material according to any one of items E1 to E79, wherein the (N-doped) carbon nanofoam material is an N-doped carbon nanofoam material.

E81. A composite catalytic material according to any one of items E1 to E79, wherein selected from the group consisting of (all of which may be partially carbonised);
CoP@a-CoOx:Ppy-TsOH:C_{nf}-Nₓ;
CoP@a-CoOx:PANi:Ppy-TsOH:C_{nf}-Nₓ;
Co:Ppy-TsOH:C_{nf};
Co:PANi:Ppy-TsOH:C_{nf};
Co:Ppy-TsOH:C_{nf}-Nₓ;
Co:PANi:Ppy-TsOH:C_{nf}-Nₓ;
Co:Ppy-TsOH:C_{nf};
Co:PANi:Ppy-TsOH:C_{nf};
CoP:Ppy-TsOH:C_{nf};
CoP:PANi:Ppy-TsOH:C_{nf};
MoS₂:Ppy-TsOH:C_{nf}-Nₓ;
MoS₂:PANi:Ppy-TsOH:C_{nf}-Nₓ;
irOₓ:Ppy-TsOH:C_{nf}-Nₓ;
irOₓ:PANi:Ppy-TsOH:C_{nf}-Nₓ;
Pt:Ppy-TsOH:C_{nf}-Nₓ;
Pt:PANi:Ppy-TsOH:C_{nf}-Nₓ;
Pt-TI-W:Ppy-TsOH:C_{nf}-Nₓ;
Pt-TI-W:PANi:Ppy-TsOH:C_{nf}-Nₓ;
WC:Ppy-TsOH:C_{nf}-Nₓ;
WC:PANi:Ppy-TsOH:C_{nf}-Nₓ;
Ni:Ppy-TsOH:C_{nf}-Nₓ;
Ni:PANi:Ppy-TsOH:C_{nf}-Nₓ;
NiFe:Ppy-TsOH:C_{nf}-Nₓ;
NiFe:PANi:Ppy-TsOH:C_{nf}-Nₓ;
V₂O₅:Ppy-TsOH:C_{nf}-Nₓ;
V₂O₅:PANi:Ppy-TsOH:C_{nf}-Nₓ;
TI:PPyTSOF:C_{nf}-Nₓ;
TI:PANi:PPyTSOF:C_{nf}-Nₓ;
Nb:Ppy-TsOH:C_{nf}-Nₓ; and
Nb:PANi:Ppy-TsOH:C_{nf}-Nₓ.

F1. A method forming a composite catalytic material, comprising:
(i) forming an electrically conducting polymer by oxidative polymerisation in the presence of an (N-doped) carbon nanofoam material to form a polymer:N-doped carbon nanofoam composite;
(ii) depositing a catalytic metal on the (N-doped) carbon nanofoam material; and
(iii) optionally partially carbonizing the electrically conductive polymer.

F2. The method according to item F1, wherein step (ii) comprises co-dispersing the materials and removing the solvent.

F3. The method according to item F2, wherein the co-dispersion is carried out using sonication.

F4. The method according to items F2 or F3, wherein after the removal of the solvent, the resultant material may optionally be partially carbonised by heating in an inert atmosphere to a temperature sufficient to degrade the electrically conductive polymer.

F5. The method according to item F4, wherein the inert atmosphere is an argon atmosphere.

F6. The method according to item F4 or F5, wherein the resultant material is heated at a temperature from 500° C. to 1100° C.

F7. The method according to any one of items F4-F6, wherein the resultant material is heated at a temperature from 700° C. to 900° C.

F8. The method according to any one of items F4-F7, wherein the resultant material is heated at a temperature from 750° C. to 850° C.

F9. The method according to any one of items F6-F8, wherein the resultant material is heated for a time of 30 minutes to 4 hours.

F10. The method according to any one of items F6-F9, wherein the resultant material heated for a time of 1 to 3 hours.

F11. The method according to any one of items F1-F10, wherein the polymerisation of step (i) is carried out prior to combination with the catalytic metal.

F12. The method according to any one of items F1-F11, wherein the formation of the electrically conductive polymer in step (i) is carried out in the presence of a non-polymeric acid.

F13. The method according to item F12, wherein the non-polymeric acid is a non-polymeric aromatic sulfonic acid.

F14. The method according to item F12, wherein the non-polymeric acid is a non-polymeric aromatic carboxylic acid.

F15. The method according to item F12, wherein the non-polymeric acid is benzene sulfonic acid.

F16. The method according to item F12, wherein the non-polymeric acid is toluene sulfonic acid.

F17. The method according to any one of items F1-F16, wherein step (i) comprises forming a polypyrrole in the presence of an (N-doped) carbon nanofoam material and polyaniline to form a polypyrrole:polyaniline:(N-doped) carbon nanofoam material nanofoam composite.

F18. The method according to item F17, wherein the polypyrrole:polyaniline:(N-doped) carbon nanofoam material composite is PANi:polypyrrole-TsOH:(N-doped) carbon nanofoam material:CoP@a-CoOx,

F19. The method according to item F17, wherein the polypyrrole:polyaniline:(N-doped) carbon nanofoam material composite is PANi:polypyrrole-TsOH:(N-doped) carbon nanofoam material:cobalt.

F20. A method according to any one of items F1-F19, wherein the composite catalytic material formed is in accordance with any one of items E1-E81.

F21. A composite catalytic material as formed by the method of any one of items F1-F20.

G1. The use of the composite catalytic material as described in any one of items E1-E81 or F21 in an electrode in a fuel cell.

G2. The use of a composite catalytic material as described in any one of items E1-E81 or F21 to promote a four-electron redox reaction.

G3. The use of a composite catalytic material as described in any one of items E1-E81 or F21 to promote a direct (one-step) redox reaction to convert oxygen directly to water.

H1. A method comprising applying the composite catalytic material as described in any one of items E1-E81 to an electrode.

H2. A method according to item H1, wherein the composite catalytic material is applied to the electrode by spin coating a dispersion of the composite onto the electrode surface.

H3. A method according to item H1, wherein the composite catalytic material is applied to the electrode by dip coating a dispersion of the composite onto the electrode surface.

H4. A method according to item H1, wherein the composite catalytic material is applied to the electrode by drop casting a dispersion of the composite onto the electrode surface.

H5. A method according to item H1, wherein the composite catalytic material is applied to the electrode by spray coating a dispersion of the composite onto the electrode surface.

H6. A method according to item H1, wherein the composite catalytic material is applied to the electrode by or brush coating a dispersion of the composite onto the electrode surface.

H7. A method according to any one of items H1-H6, wherein the composite catalytic material is applied to the electrode surface prior to carbonisation, and the partial carbonisation step is carried out in situ on the electrode.

H8. A method according to any one of items H1-H7, wherein the composite catalytic material may be applied to the electrode as a dispersion with a binder (i.e. to improve adhesion to the surface).

H9. A method according to item H8, wherein the binder is a fluorinated acid polymer.

H10. A method according to item H9, wherein the binder is used at below 5 wt %.

H11. A method according to item H9, wherein the binder is used at below 3 wt %.

K1. A fuel cell comprising a composite catalytic material according to any one of items E1-E81 or F21.

K2. A fuel cell (100) comprising:
a polymer electrolyte membrane (101) having a first electrode (102) on one side and a second electrode (103) on an opposed side, wherein the polymer electrolyte membrane (101), the first electrode (102) and the second electrode (103) are arranged between a first plate (104) and a second plate (105);
wherein the first plate (104) is arranged adjacent the first electrode (102) and the second plate (105) is arranged adjacent the second electrode (105), wherein the first plate optionally defines, at least in part, flow channels facing the first electrode (102) and configured to provide fluid to and receive fluid from the first electrode (102);
one or more first catalyst layers between the first plate (104) and the second plate (105);
   and wherein
the one or more first catalyst layers comprises a composite catalytic material comprising
   a catalyst comprising a metal or metal oxide of group 4 to 11, and
   an electrically conductive material comprising an electrically conductive polymer,
   said catalyst and electrically conductive material being supported by an (N-doped) carbon nanofoam material.

K3. The fuel cell of item K2, wherein the composite catalytic material is according to any one of items E1-E81 or F21.

K4. The fuel cell of item K3, wherein the composite catalytic material coats the first electrode.

K5. The fuel cell of item K4, wherein the composite catalytic material has a superstructure of coalesced particles, said particles having a diameter of from 0.01 to 2 μm, the superstructure having a tortuous path of open pores at least 3 times the average diameter of the individual particles.

K6. The fuel cell according to any one of items K2-K5, wherein the composite catalytic material comprises partially carbonised electrically conductive polymer selected from polypyrrole, polyaniline, or mixtures thereof.

K7. The fuel cell according to any one of items K2-K6, wherein the metal or metal oxide in the composite catalytic material comprises a cobalt-based catalyst.

K8. The fuel cell according to item K7, wherein the metal or metal oxide in the composite catalytic material comprises metallic cobalt.

K9. The fuel cell according to item K7, wherein the metal or metal oxide in the composite catalytic material on the first electrode comprises CoP nanoparticles embedded in amorphous cobalt oxides (CoOx) nanoplates with a heterojunction-like structure (Cop@a-CoOx plate).

K10. The fuel cell according to K4, wherein the first electrode is coated with a first composite catalytic material on the side between the first plate and the first electrode, and coated with a second composite catalytic material on the side between the first electrode and the polymer electrode membrane,

K11. The fuel cell according to K10, wherein
the first composite catalytic material comprises
   partially carbonised electrically conductive polymer selected from polypyrrole, polyaniline, or mixtures thereof, and
   a catalyst comprising a metal or metal oxide comprising CoP nanoparticles embedded in amorphous cobalt oxides (CoOx) nanoplates with a heterojunction-like structure (Cop@a-CoOx plate); and
   wherein the second composite catalytic material comprises
      partially carbonised electrically conductive polymer selected from polypyrrole, polyaniline, or mixtures thereof, and
      a catalyst comprising a metal or metal oxide comprising metallic cobalt.

K12. The fuel cell according to any one of items K2-K11, further comprising one or more gas diffusion layers configured to promote, respectively, one or more of:
the diffusion of fuel to and/or from flow channels of the second plate;
the diffusion of oxygen, such as from air, to and/or from the flow channels of the first plate;
the diffusion of fuel or derivative thereof to and/or from the membrane; and
the diffusion of fuel or derivative thereof to and/or from the membrane.

K13. The fuel cell according to item K12, wherein the gas diffusion layer has a hydrophobic coating.

K14. The fuel cell according to any one of items K2-K13, wherein the first electrode comprises a carbon cloth.

K15. The fuel cell according to any one of items K2-K13, wherein the first electrode comprises a carbon paper.

K16. The fuel cell according to any one of items K2-K13, wherein the first electrode comprises a metal frit.

K17. The fuel cell according to item K12, wherein the gas diffusion layer comprises a porous structure of fibres or open-cell foam.

K18. The fuel cell according to any one of items K2-K17, wherein the first plate and the second plate are configured to contain, at least in part, the fuel, oxygen and reaction product within the fuel cell and none, one or more of:
comprise a rigid element to provide structural support for the first electrode, the membrane and the second electrode;
comprise conductive elements for electrically coupling to the first and second electrodes and to a circuit to transport electrons between the electrodes;
comprise a structure in which the first flow channels and second flow channels are formed.

K19. A fuel cell stack comprising a plurality of fuel cells arranged in series, said plurality of fuel cells comprising at least one fuel cell according to any of items K1 to K18.

K20. A fuel cell stack according to item K19, wherein the fuel cell stack does not comprise any cooling elements.

K21. A fuel cell according to item K2, wherein the catalyst on the one or more first catalyst layer catalyses a OER and/or ORR reaction.

K22. The fuel cell according to any one of items K1-K21, wherein the second plate comprises flow channels formed in a surface thereof facing the second electrode and configured to provide fluid to and receive fluid from the second electrode.

K23. The fuel cell according to any one of items K1-K22 claims, wherein the fuel cell comprises a gas diffusion layer between said polymer electrolyte membrane (101) and the second electrode (103).

K24. The fuel cell according to item K23, wherein the gas diffusion layer has a hydrophobic coating.

K25. The fuel cell according to item K23 or item K24, wherein the gas diffusion layer comprises a porous structure of fibres or open-cell foam.

K26. The fuel cell according to any one of items K1 to K25, wherein the fuel cell is configured to receive hydrogen as said fuel via said flow channels of the second plate.

K27. The fuel cell according to any one of items K1 to K26, wherein the fuel cell comprises a hydrogen fuel cell, wherein said fuel comprises hydrogen, said oxidant comprises air and said reaction product comprises water.

K28. The fuel cell according to any one items K1 to K27, wherein the first electrode comprises a textile layer of electrically conductive fibres.

K29. The fuel cell according to item K28, wherein the fibres of the textile layer comprise a metal.

K30. The fuel cell according to item K29, wherein the textile layer comprises a non-platinum-group metal.

K31. The fuel cell according to item K30, wherein the textile layer comprises a non-woven fabric.

K32. The fuel cell according to any one of items K1 to K31, wherein the first plate and the second plate are configured to contain, at least in part, the fuel, oxygen and reaction product within the fuel cell and none, one or more of:
comprise a rigid element to provide structural support for the first electrode, the membrane and the second electrode;
comprise conductive elements for electrically coupling to the first and second electrodes and to a circuit to transport electrons between the electrodes;
comprise a structure in which the first flow channels and second flow channels are formed.

K33. The fuel cell according to any one of items K1 to K32, wherein the fuel cell includes a peripheral gasket configured to be sandwiched between the first plate and the second plate and contain at least the polymer electrolyte membrane, the first electrode, the second electrode, the one or more first catalyst layers and the one or more second catalyst layers.

K34. The fuel cell according to any one of items K1 to K33, wherein
the catalyst is cobalt,
the electrically conductive material is PANi:PPY-TsOH; wherein
   the electrically conductive polymer is partially carbonised; and
the carbon nanofoam material is an N-doped carbon nanofoam.

K35. A fuel cell stack comprising a plurality of fuel cells arranged in series, said plurality of fuel cells comprising at least one fuel cell according to any of items K1 to K33.

### Example 1—Preparation of N-Doped Carbon Nanofoam

171g of table sugar was dissolved in 100 ml deionized (Di) water. The mixture was heated and stirred to dissolve the sugar until fully dissolved. The final temperature when the sugar becomes fully dissolved was approximately 60° C.-80° C.

The mixture was allowed to cool to approximately 45° C., and 3 mg of naphthalene was added. The mixture was stirred to dissolve the naphthalene.

The resultant mixture was added to a Teflon lined hydrothermal reactor. The reactor was sealed and placed into oven at 155° C. for 5 hours.

The resultant mixture was allowed to cool, then the carbonaceous material was removed and thoroughly cleaned using physical dissolution, decanting, and Di filtering of the material, sequentially in that order. The filtrate was dried under vacuum in an oven at 50° C. for 6-12 hrs.

The material was then milled in a ball mill for 24+hrs using 5 mm-10 mm steel bearings (other bearings such as alumina or zirconium may also be used), then sieved through a 43-63 micron polyamide filter.

The resultant material was nitrogen doped by treating with 6 M HNO₃ for 8 h at 100° C., then neutralized using mild sodium bicarbonate solution and rinsing in Di water until pH of 6.5-7 is reached. The material was then dried under vacuum at . . . 50° C. for 6-12 hrs.

SEM micrographs of the resultant material are shown in FiGS. 2a and 2b. The material is a superstructure of small particulate material having diameters of approximately 1-2 μm, which are coalesced to form a foamed porous material.

### Example 2—Preparation of PPy:PANi:TsOH:N-Doped C Composite

0.6g of carbon nanofoam powder from Example 1 was ultrasonically dispersed in 100 ml isopropyl alcohol for 30 min. 3 mmol of pyrrole and 100 ml of Di water were added to the solution and stirred (no ultrasonication) for another 30 mln on a hot-plate stirrer. 100 ml of Ammonium Peroxydisulfate solution (with conc. Of 0.06M), 0.1902g of Toluene sulfonic acid, and 10% by wt PANi (in emeraldine crystal form) were added and then stirred at room temperature for 4 h.

The mixture was filtered through Millipore PTFE and silica frit Buchner funnels and washed 3 times with Di water and ethanol (76%) alternately. The wet filtrate was then dried at 45° C. under vacuum for 12 h to obtain PANi-PpyTsOH/C_{nf}-Nₓ.

### Example 3—Formation of an ORR Catalyst Composite Material

0.5g of PANi-PpyTsOH/C_{nf}-Nₓ backbone from Example 2 and 10.55% by wt amount of cobalt acetate were blended with 200 ml Di water and ultrasonicated for 1 h with subsequent vigorous stirring for 2 hours. The solvent was then evaporated under reduced pressure.

The obtained powder was then heat-treated at 800° C. for 2 h under an Argon atmosphere to obtain:Co-PANi-PpyTsOH/C_{nf}-Nₓ.

### Example 4—Formation of Cop@a-CoOx Catalyst Material

0.5g of cobalt acetate was added to 36 ml of ethylene glycol and ultrasonicated for 30 min. The solution was heated to 200° C. for 5 h under continuous stirring.

The solution was cooled to room-temp (naturally) and the pink precipitate was recovered by Millipore Buchner funnel filtration. Subsequently the material was washed with Di water and ethanol 3 times, then dried at 60° C. overnight (roughly 12 hrs).

The obtained filtrate was then introduced into a tube furnace with NaH₂PO₂ in the upstream location of the tube furnace, and in a mass ratio of 10:1 (NaH₂PO₂:filtrate) under argon atmosphere. Argon is flushed before heating for 30 min, then heated at 300° C. with a ramping rate of 1° C./min (until reaching 300° C.). Heating at 300° C. Is maintained for 1 h.

The resultant product is a Cop@a-CoOx heterojunction bifunctional catalyst material.

The intermediate filtrate and CoP@a-CoOx plate may be analysed using powder XRD measurements on a RIgaku Smartlab diffractometer using filtered Cu-Kα radiation (λ =1.5418 Å) in 20 range of 10°-90°. The morphologies of the samples may be observed by a HiTACHi-S4800 field-emission SEM and a FEi Tecnai G2T20 transmission electron microscope. STEM-EDX line scan and element mapping may be taken on a FEi Tecnai G2 F30 STWiN field-emission transmission electron microscope equipped with an EDX analyzer at 200 kV. XPS measurements may be conducted on a PHi5000 VersaProbe spectrometer equipped with an Al-Kα X-ray source and the data may be fitted by the software package XPSPEAK. The specific surface areas and pore size distributions may be determined from the N₂ adsorption-desorption isotherms using the BET and Barrett-Joyner-Halenda methods.

### Example 5—Formation of OER Composite Catalyst Material

Both Cop@a-CoOx (10.55% wt) from Example 5 and polymer composite (0.5 g) from Example 2 were blended with 200 ml pH 6.8-7 Di water and ultrasonicated for 1 h with subsequent vigorous stirring for 2 hours. The solvent was then evaporated under reduced pressure and the resultant powder dried under vacuum at 45° C. for 12 hours to yield the desired composite catalyst material.

### Example 6—Formation of Test Fuel Cells

A test fuel cell was constructed with a MEA in the following order:
titanium felt cathode/conductive GDL
Nafion® 212 PEM
carbonaceous paper anode/conductive GDL

These were sandwiched between suitable front and back plates and to form an operative fuel cell.

Various catalytic composites were used in the test cell, and generally applied to the cathode/anode as follows:

### General Method of Cathode Formation

Catalyst inks were prepared by dispersing 10 mg of the catalyst powder in a mixture of Millipore water (36.5 μL, 18.2MΩcm) and ethanol (300 μL), into which 1 wt % Nafion solution (108.5 μL, SigmaAldrich) was added as a binder phase. The resulting mixture was sonicated for 60 min.

TItanium frit of 63 μm pore diameter is cleaned in EtOH and ultrasonicated in 60% EtOH solution for 1 hr with subsequent rinsing in acetone to remove all oils and surface contaminates. Then an allquot of 8.8 μL of the catalyst ink was drop cast onto the TItanium Frit (0.247 cm², Pine instrument), resulting in a loading of 800 μg·cm⁻².

The ORR catalyst is added to the opposite side of the TItanium frit at this time using identical steps, save for the catalytic ink that is used.

After deposition and removal of solvents, the electrode is exposed to moisture which hydrates it to average moisture levels of 5000 ppm of water content. Moisture has to then be removed to lower than 500 ppm in order to allow for the integration of the material into a battery cell and allow for proper operation.

A dehumidified dry-air stream at 150° C. Is utilized with a residence time of 2-minutes to reach target moister levels. Infrared Radiant Heating is used as the heating mechanism.

### General Method of Anode Formation

Catalyst inks were prepared by dispersing 10 mg of the catalyst powder in a mixture of Millipore water (36.5 μL, 18.2MΩcm) and ethanol (300 μL), into which 1 wt % Nafion solution (108.5 L, SigmaAldrich) was added as a binder phase. The resulting mixture was sonicated for 60 min.

Then an aliquot of 8.8 μL of the catalyst ink was drop cast onto the carbon-paper or felt electrode (0.247 cm², Pine instrument), resulting in a loading of 800 μg·cm⁻². After deposition and removal of solvents, the electrode is exposed to moisture which hydrates it to average moisture levels of 5000 ppm of water content. Moisture has to then be removed to lower than 500 ppm in order to allow for the integration of the material into a battery cell and allow for proper operation.

A dehumidified dry-air stream at 150° C. Is utilized with a residence time of 2 minutes to reach target moister levels. Infrared Radiant Heating is used as the heating mechanism.

### Test Results

Using this basic test cell, a variety of catalysts were analysed for their utility in a fuel cell. The results of selected catalysts are shown in Table 1 below:

TABLE 1

| | | On-set | Overpotential | |
|---|---|---|---|---|
| | | potential | (10 mA cm⁻²) | Tafel Slope |
| Electrolyte | Electrodes | (mV vs RHE) | (mV vs RHE) | (mV dec⁻¹) |
| 0.1M | Pt—C | 0 | 37 | 31 |
| HclO₄ | 1D—N—Mo₂C | 73 | 164 | 62 |
| | 1D—N,Co—Mo₂C | 34 | 87 | 42 |
| | 2D—N—Mo₂C | 66 | 144 | 54 |
| | 2D—N,Co—Mo₂C | 25 | 71 | 40 |
| | Co—PANI— | 5 | 40 | 32 |
| | PpyTsOH/Cnf⁻ | | | |
| | Nx | | | |
| | MoS₂ | 48 | 125 | 45 |
| 0.1M | Pt—C | 0 | 44 | 41 |
| KOH/NaOH | 1D—N—MO₂C | 140 | 239 | 80 |
| | 1D—N,Co—Mo₂C | 68 | 143 | 54 |
| | 2D—N—Mo₂C | 106 | 187 | 52 |
| | 2D—N,Co—Mo₂C | 36 | 92 | 47 |
| | Co—PANI— | 15 | 46 | 42 |
| | PpyTsOH/C_{nf-} | | | |
| | Nx | | | |
| | MOS₂ | 56 | 138 | 50 |

**RHE = Reversible hydrogen Electrode (which is Pt—C 20% wt Pt on Vulkan)
**catalysts tested here are only for the HER and OER reactions

The data show that cobalt:PANi:PPY-TsOH:N-doped carbon according to example 4 provided excellent results.

The system was further investigated to determine the suitability of other cobalt salts and conductive polymer combinations.

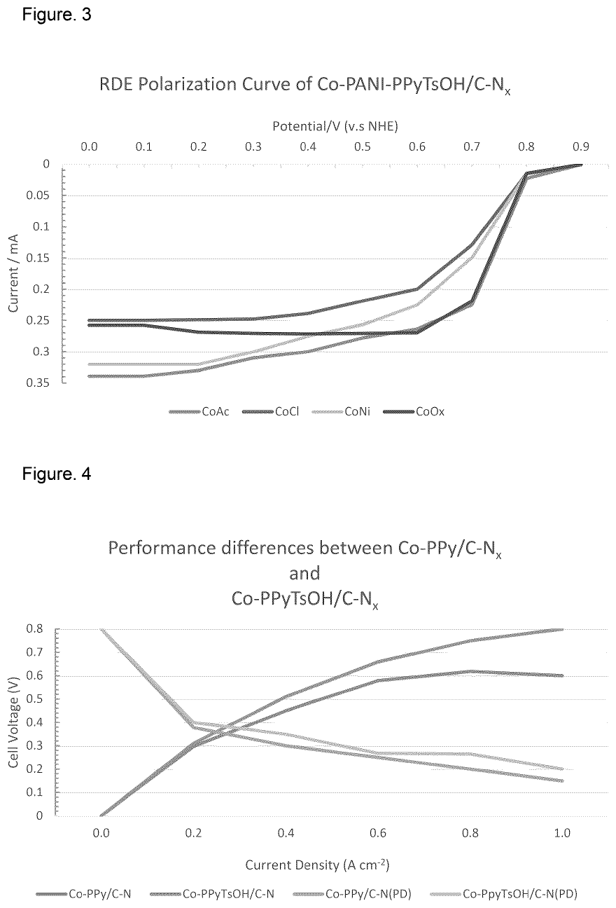

FiG. 3 shows the RDE polarisation curve for various cobalt salts-cobalt acetate, cobalt chloride, cobalt nitrate, and cobalt oxide. Cobalt acetate and cobalt nitrate provide the highest current at low potential, with cobalt acetate providing the best overall results.

FiG. 4 shows a plot of the current density vs power density and current density vs cell voltage for polypyrrole-based systems, with and without toluene sulfonic acid as the polymerising acid. The plot shows that doping with toluene sulfonic acid provides a more favourable power density and cell voltage across all current densities.

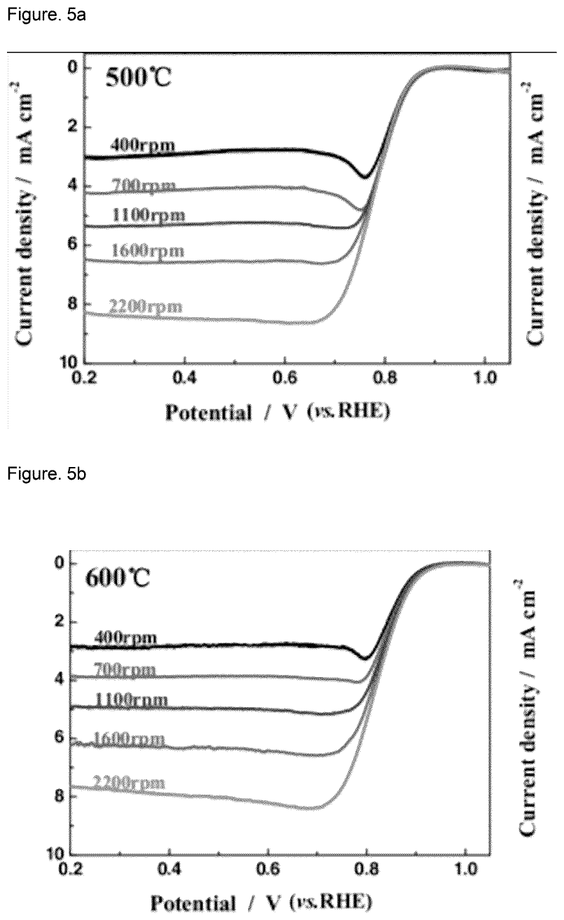

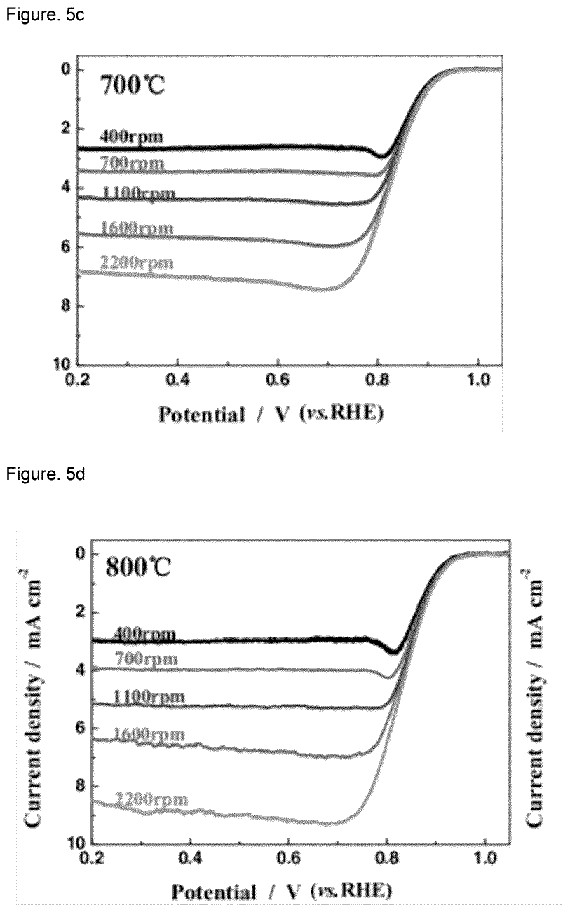

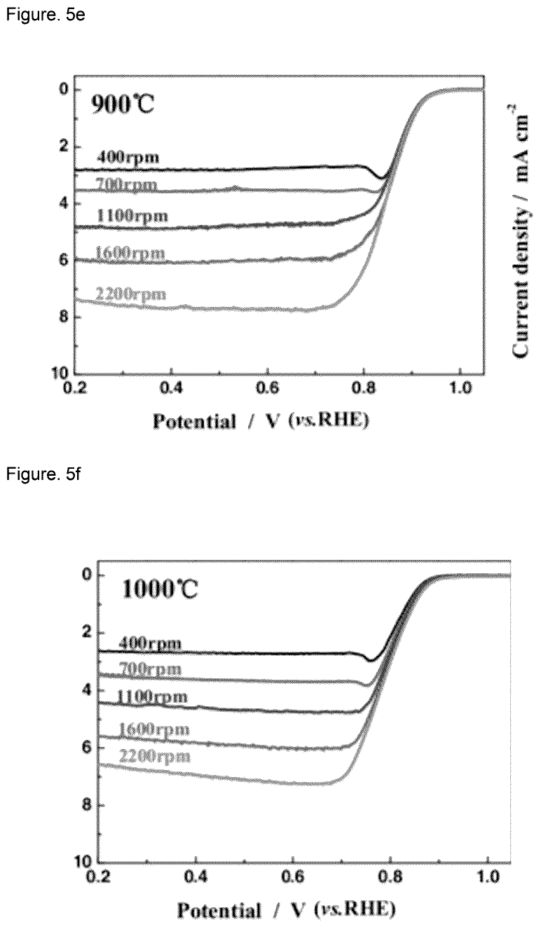

FiGS. 5a to 5f show the current density vs potential for Co:PANi:Ppy-TsOH:N-doped carbon composite materials formed in line with Example 4, with the heating temperature being varied. The plots show the best performance is achieved when the sample is heated at 800° C., in line with Example 3.

### Example 7

A variety of catalysts in the periodic group 5-11 were tested and their performance tested in a fuel cell environment.

### Basic Protocol for Catalyst Synthesis

The basic protocol for the synthesis of the catalyst material was via the polyol method. This methodology is well known in the art and comprises suspending the metal precursor in a polyol such as ethylene glycol and heating the suspension. The necessary steps were then taken to cause crystallisation of each catalytic species.

The following materials were obtained by the following methods.

industrial grade MoS₂ was purchased from Sigma Aldrich. The purchased MoS₂ was then distributed into nanoplatelets using ultra sonification in an industry standard process.

irOₓ was purchased from Sigma Aldrich.

V₂O₅ purchased directly from Chemcor.

### Test Data

The data provided in Table 2 was collected using a Rotating Disc Electrode and Sweeping Probe Voltammetry, as well as testing and measuring mock-up fuel cell membrane electrode assemblies (MEAs) using a standard Pt/C reference electrode.

| | Over | | Current |
|---|---|---|---|
| Catalyst | Voltage(mV) | Conductivity (S/cm⁻²) | Density(A/cm²) |
| PpyTsOH/C_{nf}—Nₓ | 100-300 | 20-150 | 10⁻⁶ to 10⁻¹² |
| PpyTsOH/C | 400-800 | 100-500 | N/A |
| Co—PpyTsOH/C | 80-140 | 80-170 | 10⁻⁴ to 10⁻⁸ |
| CoP—PpyTsOH/C_{nf}—Nₓ | 40-150 | 2-50 | 10⁻² to 10⁻⁸ |
| Co—PpyTsOH/C_{nf}—Nₓ | 20-80 | 2-100 | 10⁻² to 10⁻⁴ |
| MoS₂—PpyTsOH/C_{nf}—Nₓ | 40-100 | 10-100 | 10⁻³ to 10⁻⁸ |
| IrOx—PpyTsOH/C_{nf}—Nₓ | 20-80 | 30-150 | 10⁻⁸ to 10⁻¹² |
| Pt—PpyTsOH/C_{nf}—Nₓ | 50-200 | 5-100 | 10⁻³ to 10⁻¹² |
| Pt—Ti—W—PpyTsOH/C_{nf}—Nₓ | 30-150 | 10-200 | 10⁻³ to 10⁻¹² |
| WC—PpyTsOH/C_{nf}—Nₓ | 25-100 | 10-100 | 10⁻² to 10⁻⁸ |
| Nb—PpyTsOH/C_{nf}—Nₓ | 50-200 | 8-95 | 10⁻⁵ to 10⁻¹² |
| Ni—PpyTsOH/C_{nf}—Nₓ | 130-400 | 2-50 | 10⁻² to 10⁻¹² |
| NiFe—PpyTsOH/C_{nf}—Nₓ | 50-100 | 2-50 | 10⁻² to 10⁻¹² |
| Ti—PpyTsOH/C_{nf}—Nₓ | 150-400 | 4-50 | 10⁻⁶ to 10⁻¹² |
| V₂O₅—PpyTsOH/C_{nf}—Nₓ | 40-80 | 30-100 | 10⁻⁶ to 10⁻¹² |

1. A fuel cell comprising one or more first catalyst layers, wherein said one or more first catalyst layer comprises a composite catalytic material comprising
a catalyst comprising a metal or metal oxide of group 4 to 11, and
an electrically conductive material comprising an electrically conductive polymer,
said catalyst and electrically conductive material being supported by an (N-doped) carbon nanofoam material.

2. The fuel cell of claim 1 comprising:
a polymer electrolyte membrane having a first electrode on one side and a second electrode on an opposed side, wherein the polymer electrolyte membrane, the first electrode and the second electrode are arranged between a first plate and a second plate;
wherein the first plate is arranged adjacent the first electrode and the second plate is arranged adjacent the second electrode, wherein the first plate optionally includes flow channels formed in a surface thereof facing the first electrode and configured to provide fluid to and receive fluid from the first electrode;
said one or more first catalyst layers between the first plate and the second plate; and wherein
the one or more first catalyst layers comprises a composite catalytic material comprising
a catalyst comprising a metal or metal oxide of group 4 to 11, and
an electrically conductive material comprising an electrically conductive polymer,
said catalyst and electrically conductive material being supported by an (N-doped) carbon nanofoam material.

3. The fuel cell of claim 1, wherein the composite catalytic material coats the first electrode.

4. The fuel cell of claim 3, wherein the composite catalytic material has a superstructure of coalesced particles, said particles having a diameter of from 0.01 to 2 μm.

5. The fuel cell of according to claim 1, wherein the superstructure has a tortuous path of open pores at least 3 times the average diameter of the individual particles.

6. The fuel cell according to claim 1, wherein the composite catalytic material comprises
a catalyst comprising a metal or metal oxide of group 4 to 11,
an electrically conductive material comprising a partially carbonised electrically conductive polymer,
said catalyst and electrically conductive material being supported by an (N-doped) carbon nanofoam material, and
said (N-doped) carbon nanofoam material being enveloped in the electrically conductive material.

7. The fuel cell according to claim 1, wherein the electrically conductive material comprises a core comprising electrically conductive polymer, and a shell comprising conductive carbonised material.

8. The fuel cell according to claim 1, wherein the electrically conductive polymer is a poly-N-aryl polymer.

9. The fuel cell according to claim 8, wherein the electrically conductive polymer is selected from a polypyrrole, a polyaniline, or mixtures thereof.

10. The fuel cell according to claim 1, wherein the metal or metal oxide in the composite catalytic material comprises a cobalt-based catalyst.

11. The fuel cell according to claim 10, wherein the metal or metal oxide in the composite catalytic material comprises metallic cobalt.

12. The fuel cell according to claim 10, wherein the metal or metal oxide in the composite catalytic material on the first electrode comprises CoP nanoparticles embedded in amorphous cobalt oxides (CoOx) nanoplates with a heterojunction-like structure (CoP@a-CoOx plate).

13. The fuel cell according to claim 2, wherein the first electrode is coated with a first composite catalytic material on the side between the first plate and the first electrode, and coated with a second composite catalytic material on the side between the first electrode and the polymer electrode membrane.

14. The fuel cell according to claim 13, wherein the first composite catalytic material comprises:
partially carbonised electrically conductive polymer selected from polypyrrole, polyaniline, or mixtures thereof, and
a catalyst comprising a metal or metal oxide comprising CoP nanoparticles embedded in amorphous cobalt oxides (CoOx) nanoplates with a heterojunction-like structure (CoP@a-CoOx plate); and
wherein the second composite catalytic material comprises
partially carbonised electrically conductive polymer selected from polypyrrole, polyaniline, or mixtures thereof, and
a catalyst comprising a metal or metal oxide comprising metallic cobalt.

15. The fuel cell of claim 1, wherein the (N-doped) carbon nanofoam material is an N-doped carbon nanofoam material.

16. A fuel cell comprising one or more first catalyst layers, wherein said one or more first catalyst layer comprises a composite catalytic material comprising
a catalyst comprising cobalt,
an electrically conductive material comprising an electrically conductive polymer, wherein the electrically conductive polymer is PANi:PPY-TsOH; wherein
the electrically conductive polymer is partially carbonised; and
said catalyst and electrically conductive material being supported by an N-doped carbon nanofoam material.

17. A fuel cell stack comprising a plurality of fuel cells arranged in series, said plurality of fuel cells comprising at least one fuel cell according to any of the preceding claims.

18. A composite catalytic material comprising
a catalyst comprising a metal or metal oxide of group 4 to 11, and
an electrically conductive material comprising an electrically conductive polymer,
said catalyst and electrically conductive material being supported by an (N-doped) carbon nanofoam material.

19. The composite catalytic material according to claim 18, wherein the metal or metal oxide of group 4 to 11 is selected from metallic Co, Fe, Ni; alloys of Co, Fe, Ni; oxides of Co, Fe, Ni; or mixtures thereof, wherein preferably, when present, Fe is in a 3+oxidation state.

20. The composite catalytic material according claim 19, wherein the composite catalytic material comprises a cobalt based catalyst.

21. The composite catalytic material according to claim 20, wherein the cobalt based catalyst is metallic cobalt.

22. The composite catalytic material according to claim 18, wherein the electrically conductive polymer is a poly-N-aryl polymer.

23. The composite catalytic material according to claim 18, wherein the electrically conductive polymer is partially carbonised.

24. The composite catalytic material according to claim 18, wherein the electrically conductive material comprises a core comprising electrically conductive polymer, and a shell comprising conductive carbonised material.

25. The composite catalytic material according to claim 18, wherein the composite catalytic material has a superstructure of coalesced particles, said particles having a diameter of from 0.01 to 2 μm.

26. The composite catalytic material according to claim 24, wherein the superstructure has a tortuous path of open pores at least 3 times the average diameter of the individual particles.

27. The composite catalytic material according to claim 26, wherein the superstructure has a tortuous path of open pores 5 to 50 times the average diameter of the individual particles.

28. The composite catalytic material according to claim 18, wherein the material contains from 1 to 20 wt % catalytic metal.

29. The composite catalytic material according to claim 18, wherein the (N-doped) carbon nanofoam material is enveloped by the electrically conductive material.

30. The use of the composite catalytic material according to claim 18 to promote a four-electron redox reaction.

31. The use of the composite catalytic material according to claim 18 to promote a direct (one-step) redox reaction to convert oxygen to water.

32. A method forming the composite catalytic material of claim 18, comprising:
(i) forming an electrically conducting polymer by oxidative polymerisation in the presence of an (N-doped) carbon nanofoam material to form a polymer:N-doped carbon nanofoam composite;
(ii) depositing a catalytic metal on the (N-doped) carbon nanofoam material; and
(iii) optionally partially carbonizing the electrically conductive polymer.

33. The method according to claim 32, wherein step (ii) comprises co-dispersing the materials and removing the solvent.

34. The method according to claim 33, wherein after the removal of the solvent, the resultant material may optionally be partially carbonised by heating in an inert atmosphere to a temperature sufficient to degrade the electrically conductive polymer.

35. The method according to claim 34, wherein the resultant material is heated at a temperature from 500° C. to 1100° C.

36. The method according to claim 35, wherein the resultant material is heated for a time of 30 minute to 4 hours.

37. The method according to claim 32, wherein the polymerisation of step (i) is carried out prior to combination with the catalytic metal.

38. The method according to claim 32, wherein the formation of the electrically conductive polymer in step (i) is carried out in the presence of a non-polymeric acid.

39. A method comprising applying the composite catalytic material as described in claim 18 to an electrode.

40. The method according to claim 39, wherein the composite catalytic material is applied to the electrode surface prior to carbonisation, and the partial carbonisation step is carried out in situ on the electrode.

41. The method according to claim 40, wherein the composite catalytic material may be applied to the electrode as a dispersion with a binder.

42. The method according to claim 41, wherein the binder is a fluorinated acid polymer.

43. The method according to claim 42, wherein the binder is used at below 5 wt %.
